(19) United States
(12) Patent Application Publication
(10) Pub. No.: US 2007/0190444 A1
(43) Pub. Date: Aug. 16, 2007

(54) TONER, DEVELOPER, TONER-CONTAINING CONTAINER, PROCESS CARTRIDGE, IMAGE-FORMING APPARATUS AND IMAGE-FORMING PROCESS

(76) Inventors: Akihiro Kotsugai, Numazu-shi (JP); Fumihiro Sasaki, Fuji-shi (JP); Shinya Nakayama, Numazu-shi (JP); Koichi Sakata, Yamato-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/673,799

(22) Filed: Feb. 12, 2007

(30) Foreign Application Priority Data
Feb. 13, 2006 (JP) 2006-034885
Dec. 28, 2006 (JP) 2006-354620

(51) Int. Cl. G03G 9/08

(52) U.S. Cl. 430/108.6; 430/108.1; 430/109.4; 430/123.51

(57) ABSTRACT

Toners, developers, toner-containing containers, process cartridges, image forming apparatuses and image forming processes are provided that may maintain proper transfer ability and cleaning property for long period, exhibit less image fluctuation, and represent less embedding of external additives even under stirring the developer at use, and also afford stable flowability and charging ability for long period. The toner of the present invention comprises toner base particles and secondary agglomerates, wherein the toner base particles comprise a toner material that comprises a colorant and a binding resin, and the secondary agglomerates, which being formed of fine particles, each have a secondary particle diameter of no less than 10 μm.

### BACKGROUND OF THE INVENTION

1. Field of the Invention

The present invention relates to toners suited to electrophotographic, electrostatic recording or electrostatic printing processes, developers on the basis of the toners, toner-containing containers, process cartridges, image forming apparatuses and image forming methods.

2. Description of the Related Art

Toner images are typically formed by way of depositing toners onto electrostatic latent images formed on photoconductors, then the toners are transferred and thermally fixed onto recording media in electrophotographic apparatuses or electrostatic recording apparatuses. Color images may also be formed, typically using black, yellow, magenta and cyan toners, by way of developing the respective color images, overlapping the respective toner layers on recording media, then heating and fixing the toner images simultaneously.

However, the image quality in full color copiers is typically unsatisfactory for persons familiar with printed matter, thus improvement in the image quality has been demanded so as to come close to the image quality of photography or printing matter in terms of definition and resolution in particular. In order to enhance the image quality of electrophotographic images, toners with smaller particle sizes and narrow particle size distribution are effective as well-known in the art.

Electric latent images and magnetic latent images are developed by use of toners. The toners utilized for developing the electrostatic images are typically color particles that contain colorants, charge control agents and other optional additives. The methods for producing the toners may be approximately divided into milling processes and polymerization processes. Toners are produced, in the milling processes, by melting and mixing a colorant, charge control agent and anti-offset agent to produce a uniformly dispersed mixture, then the resulting toner composition is milled and classified.

The milling processes may provide toners with some excellent properties, meanwhile being limited in terms of selecting toner raw materials. The toner compositions of the melting and mixing processes, for example, are to be milled and classified using economically feasible devices, which requiring that the toner composition after the melting and mixing step is sufficiently brittle. Consequently, the toner compositions tend to result in particles with broader particle size distributions after the milling step. In order to take copy images with proper resolution and tone, for example, finer particles with no more than 5 μm diameter and coarser particles with no less than 20 μm diameter are to be removed through a classifying step, which leading to deficiency of remarkably low yield. The milling processes may also suffer from nonuniform dispersion of additives such as colorants and charge control agents into thermoplastic resins, which possibly affecting adversely toner flowability, developing property, durability, image quality, etc.

In order to avoid these problems in the milling processes, in recent years, toner particles may be produced by suspension polymerization processes (see Japanese Patent Application Laid-Open No. 09-43909). The suspension polymerization processes may provide spherical toner particles, meanwhile suffer from poor cleaning ability. That is, in cases of developing and transferring with lower image area rates, the poor cleaning ability may be less problematic, meanwhile higher image area rates like photographic images and also untransferred toners due to paper-feed failure may bring about residual toners remaining on photoconductors, and accumulation thereof may cause background smear, furthermore, charge rollers for contact-charging photoconductors may be smeared, which disturbing the essential charge ability, and also low-temperature fixing ability may turn into insufficient, which requiring much energy for fixing toners.

On the other hand, a method for producing an indeterminate-form toner is disclosed, in which resin fine particles produced through emulsion polymerization processes are coagulated (see Japanese Patent No. 2537503). However, the toner particles produced through the emulsion polymerization processes typically contain much amount of residual surfactants at not only their surface also inside of the toner particles even after aqueous cleaning, which possibly impairing ambient stability for charging toners, leading to broad distribution of charge amount, and thus resulting in background smear of images. Furthermore, the residual surfactants may smear photoconductors, charging rollers and developing rollers, which possibly disturbing the essential charge ability.

It is also necessary that toner particles may exhibit offset resistance against heating members such as heating rollers in the fixing process under contacting and heating with the heating members (hereinafter referred to as “offset resistance”). The offset resistance may be enhanced through the existence of release agent on the surface of toner particles. Japanese Patent Application Laid-Open No. 2000-292973 and No. 2000-292978, on the contrary, disclose a method for enhancing the offset resistance by way of unevenly distributing resin fine particles on toner particle surface in addition to incorporating the resin fine particles within the toner particles. However, this proposal suffers from higher minimum-fixing temperatures, that is, the fixing property is insufficient under energy-saving conditions.

There are also the following problems in the method for producing the indeterminate-form toner through coagulating resin fine particles produced by emulsion polymerization processes; that is, fine particles of release agent are incorporated into inside of toner particles, consequently, the improvement of the offset resistance is insufficient. The toner particles are formed from melted and randomly solidified resin fine particles, release agent-fine particles, colorant fine particles, etc.; therefore, the composition like constitutional contents and molecular weight of the constitutional resin are different between the particles of the resulting toner. As a result, surface property is different between toner particles, which inhibiting stable image formation for long period. Furthermore, in lower-temperature fixing systems, resin fine particles unevenly existing on toner surface may disturb the fixing, which causes a problem that the allowable temperature range is insufficient for the fixing.

A solution suspension method is also proposed (Japanese Patent No. 3141783). This method may produce particles from polymers dissolved in organic solvents, in contrast to suspension or emulsion polymerization methods that produce particles from monomers, and thus may be advantageous in selecting wide variety of resins and easy control for polarization. However, the shell structure in this proposal, formed of resins themselves, is intended to reduce exposure of pigments or waxes onto surface; the surface condition is far from unique idea or particular construction (see Takao Ishiyama et al., Characterization and Future View of Novel Process Toner, 4th Joint Symposium of The Imaging Society of Japan & The Institute of Electrostatics Japan, Jul. 29, 2000). In the proposal described above, the toner surface is of conventional resins without particular conception with exception of shell structure, as such, intended low-temperature fixing is unsatisfactory in view of high-temperature preservability and ambient charging stability.

The suspension or emulsion polymerization processes usually employ styrene-acrylic resins rather than polyester resins, which limiting to satisfy fixing ability as well as high-temperature preservability when low-temperature fixing is intended.

In order to address the problem, polyester modified with urea-bond is proposed (see Japanese Patent Application Laid-Open No. 11-133667). However, this proposal is of the toner surface without particular conception and insufficient under more severe condition of ambient charging stability.

In recent years, making images higher quality has been investigated to realize on the base of various conceptions in the electrophotographic filed, and it has been recognized that miniaturizing and making spherical the toners is remarkably effective for making images higher quality. However, as the toners are miniaturized, the transfer ability and fixing ability tend to degrade, resulting in poor images. It has been also confirmed that making spherical the toners may improve the transfer ability (see Japanese Patent Application Laid-Open No. 09-258474). Concerning the current situation on these statuses, higher speed for forming images are demanded in the fields of color copiers and color printers. Tandem system is effective to attain the higher speed (see Japanese Patent Application Laid-Open No. 05-341617).

In the tandem system, full color images are formed on recording media by way of forming images in image forming units, transporting the images by transfer belts and duplicating sequentially the images on a sheet of recording media. Image forming apparatuses of the tandem system may provide such excellent benefits that available recording media are numerous, full-color image quality is excellent, and full-color images are formed at higher speed. In particular, the benefit to form full-color images at higher speed is distinctive compared to other color image forming apparatuses.

It has also been tried to attain higher speed along with the higher quality using the spherical toners. Spherical toners such as chemical toners may cause less inferior transferring such as less transferring rates and image voids, since developed toner images are relatively dense on photoconductors and thus the transferring pressure may be evenly applied on toner layers at transferring. However, flowability enhancers, additionally added to toners for improving transfer ability and flowability, tend to be buried into toners relatively rapidly with time compared to milled toners, thus resulting in changeable transfer ability and flowability. In particular, when images are continuously formed with smaller image areas i.e. using less amount of toners, external additives are buried within toners with time and thus the effect on flowability is lessened, therefore, the transferring property alters and then images come to significantly nonuniform; which are current problems.

### SUMMARY OF THE INVENTION

The present invention aims to solve the problems described above in the art. That is, it is an object of the present invention to provide a toner that may maintain proper transfer ability and cleaning property for long period, exhibit less image fluctuation, and represent less embedding or burial of external additives even under stirring the developer at use, and also exhibit excellent stability in terms of flowability and charging property for long period; it is another object of the present invention to provide a developer, toner-containing container, process cartridge, image forming apparatus and image forming method that retain the advantages described above.

In an aspect of the present invention, a toner is provided that comprises toner base particles and secondary agglomerates,

wherein the toner base particles comprise a toner material that comprises a colorant and a binding resin, and the secondary agglomerates, which being formed of fine particles, each have a secondary particle diameter of no less than 10 μm.

In another aspect of the present invention, the toner comprises toner base particles and secondary agglomerates,

wherein the toner base particles comprise a toner material that comprises a colorant and a binding resin, the secondary agglomerates, which being formed of fine particles, each have a secondary particle diameter of no less than 10 μm, and the number of the secondary agglomerates is 5 to 800 per gram of the toner.

Preferably, the secondary particle diameter of the secondary agglomerates is 10 to 50 μm, and the number of the secondary agglomerates is 5 to 200 per gram of the toner.

Preferably, the fine particles comprise smaller-diameter particles each having a primary particle diameter of 1 to 30 nm and larger-diameter particles each having a primary particle diameter of 30 to 200 nm.

Preferably, the secondary agglomerates comprise titanium oxide fine particles each having a primary particle diameter of 80 to 150 nm in an amount of no less than 50%.

Preferably, the toner is formed into particles by way of emulsifying or dispersing a solution or a dispersion of the toner material into an aqueous medium.

Preferably, the solution or the dispersion of the toner material comprises an organic solvent, and the organic solvent is removed at forming the particles or after forming the particles.

Preferably, the toner material comprises an active hydrogen group-containing compound and a polymer reactive with the active hydrogen group-containing compound, and the toner is formed into particles by way of reacting the active hydrogen group-containing compound and the polymer reactive with the active hydrogen group-containing compound to form an adhesive base material, and then forming particles that contain at least the adhesive base material.

Preferably, the polymer reactive with the active hydrogen group-containing compound comprises a modified polyester resin.

Preferably, the binding resin in the toner material is an unmodified polyester resin.

Preferably, the average circularity of the toner is 0.90 to 0.99.

Preferably, the shape factor SF-1, expressed by the Equation (1) below to represent a spherical level, is 100 to 150 and the shape factor SF-2, expressed by the Equation (2) to represent an irregularity lo level, is 100 to 140;

$$SF - 1 = \frac{{( MXLNG )}^{2}}{AREA} \times \frac{π}{4} \times 100 \text{:} \qquad Equation ( 1 )$$

wherein the “MXLNG” in the Equation (1) represents the maximum length of the projected shape of the toner particle on two-dimensional plane, and the “AREA” represents the area of the projected shape of the toner particle on two-dimensional plane; and

$$SF - 2 = \frac{{( PERI )}^{2}}{AREA} \times \frac{1}{4 π} \times 100 \text{:} \qquad Equation ( 2 )$$

wherein the “PERI” in the Equation (2) represents the peripheral length of the projected shape of the toner particle on two-dimensional plane, and the “AREA” represents the area of the projected shape of the toner particle on two-dimensional plane.

Preferably, the mass-average particle diameter (D₄) of the toner is 2 to 7 μm, and the ratio (D₄/Dn) of mass-average particle diameter (D₄) to number-average particle diameter (Dn) is no more than 1.25.

In still another aspect, the present invention provides a developer, comprising a toner that comprises toner base particles and secondary agglomerates,

wherein the toner base particles comprise a toner material that comprises a colorant and a binding resin, and the secondary agglomerates, which being formed of fine particles, each have a secondary particle diameter of no less than 10 μm.

Preferably, the developer is of one-component or two-component.

In still another aspect, the present invention provides a toner-containing container, comprising a toner that comprises toner base particles and secondary agglomerates, wherein the toner base particles comprise a toner material that comprises a colorant and a binding resin, and the secondary agglomerates, which being formed of fine particles, each have a secondary particle diameter of no less than 10 μm.

In still another aspect, the present invention provides a process cartridge, comprising a latent electrostatic image bearing member and a developing unit, wherein the developing unit is configured to form a visible image from a latent electrostatic image formed on the latent electrostatic image bearing member by use of a toner that comprises at least toner base particles and secondary agglomerates, and wherein the toner base particles comprise a toner material that comprises a colorant and a binding resin, and the secondary agglomerates, which being formed of fine particles, each have a secondary particle diameter of no less than 10 μm.

In still another aspect, the present invention provides an image forming apparatus comprising a latent electrostatic image bearing member, a latent electrostatic image forming unit configured to form a latent electrostatic image on the latent electrostatic image bearing member, a developing unit configured to form a visible image from a latent electrostatic image formed on the latent electrostatic image bearing member by use of a toner, a transferring unit configured to transfer the visible image to a recording medium, and a fixing unit configured to fix the transferred image to the recording medium,

wherein the toner comprises toner base particles and secondary agglomerates, the toner base particles comprise a toner material that comprises a colorant and a binding resin, and the secondary agglomerates, which being formed of fine particles, each have a secondary particle diameter of no less than 10 μm.

In still another aspect, the present invention provides an image forming method comprising forming a latent electrostatic image on a latent electrostatic image bearing member, developing the latent electrostatic image by use of a toner, transferring the visible image to a recording medium, and fixing the transferred image to the recording medium, wherein the toner comprises toner base particles and secondary agglomerates, the toner base particles comprise a toner material that comprises a colorant and a binding resin, and the secondary agglomerates, which being formed of fine particles, each have a secondary particle diameter of no less than 10 μm.

The toner according to the present invention comprises toner base particles and secondary agglomerates, wherein the toner base particles comprise a toner material that comprises a colorant and a binding resin, and the secondary agglomerates, which being formed of fine particles, each have a secondary particle diameter of no less than 10 μm.

In another aspect, the toner according to the present invention comprises at least toner base particles and secondary agglomerates, wherein the toner base particles comprise a toner material that comprises a colorant and a binding resin, the secondary agglomerates, which being formed of fine particles, each have a secondary particle diameter of no less than 10 μm, and the number of the secondary agglomerates is 5 to 800 per gram of the toner.

The toner according to the present invention may maintain proper transfer ability and cleaning property for long period, exhibit less image fluctuation, and represent less embedding or burial of external additives even under stirring the developer at use, and also exhibit excellent stability in terms of flowability and charging property for long period, thus providing high quality images.

The developer according to the present invention contains the toner according to the present invention. Accordingly, in the electrophotographic processes for forming images by use of the developer, transfer ability and cleaning property may be maintained for long period, image fluctuation is unlikely to be significant, and external additives may represent less embedding or burial even under stirring the developer at use, and excellent stability may be afforded in terms of flowability and charging property for long period, thus providing high quality images.

The toner-containing container contains the toner according to the present invention. Accordingly, in the electrophotographic processes for forming images by use of the toner in the container, transfer ability and cleaning property may be maintained for long period, image fluctuation is unlikely to be significant, and external additives may represent less embedding or burial even under stirring the developer at use, and excellent stability may be afforded in terms of flowability and charging property for long period, thus providing high quality images.

The process cartridge according to the present invention comprises a latent electrostatic image bearing member and a developing unit that is configured to form a visible image from a latent electrostatic image formed on the latent electrostatic image bearing member by use of the toner according to the present invention. The process cartridge is detachably attached to image forming apparatuses for convenience and contains the toner according to the present invention, accordingly, transfer ability and cleaning property may be maintained for long period, image fluctuation is unlikely to be significant, and external additives may represent less embedding or burial even under stirring the developer at use, and excellent stability may be afforded in terms of flowability and charging property for long period, thus providing high quality images.

The image forming apparatus according to the present invention comprises a latent electrostatic image bearing member, a latent electrostatic image forming unit, a developing unit configured to form a visible image from a latent electrostatic image formed by use of the toner according to the present invention, a transferring unit, and a fixing unit. Accordingly, transfer ability and cleaning property may be maintained for long period, image fluctuation is unlikely to be significant, and external additives may represent less embedding or burial even under stirring the developer at use, and excellent stability may be afforded in terms of flowability and charging property for long period, thus providing high quality images.

The image forming method according to the present invention comprises forming a latent electrostatic image on a latent electrostatic image bearing member, developing the latent electrostatic image by use of the toner according to the present invention, transferring the visible image to a recording medium, and fixing the transferred image to the recording medium. Accordingly, transfer ability and cleaning property may be maintained for long period, image fluctuation is unlikely to be significant, and external additives may represent less embedding or burial even under stirring the developer at use, and excellent stability may be afforded in terms of flowability and charging property for long period, thus providing high quality images.

In accordance with the present invention, problems in the art may be solved, that is, a toner is provided that may maintain proper transfer ability and cleaning property for long period, exhibit less image fluctuation, and represent less embedding or burial of external additives even under stirring at use, and also exhibit excellent stability in terms of flowability and charging property for long period; and also a developer, toner-containing container, process cartridge, image forming apparatus and image forming method are provided that may retain the advantages described above.

### BRIEF DESCRIPTION OF THE DRAWINGS

FIG. 1 exemplarily shows a schematic construction of a process cartridge according to the present invention.

FIG. 2 exemplarily shows a schematic construction of an image forming apparatus according to the present invention. FIG. 3 exemplarily shows a schematic construction of another image forming apparatus according to the present invention.

FIG. 4 exemplarily shows a partial schematic construction of a tandem-type image forming apparatus according to the present invention.

FIG. 5 exemplarily shows a partial schematic construction of another tandem-type image forming apparatus according to the present invention.

FIG. 6 exemplarily shows a schematic construction of a tandem-type color image forming apparatus according to the present invention.

FIG. 7 is a partially enlarged view of FIG. 6.

### DESCRIPTION OF THE PREFERRED EMBODIMENTS

The toner according to the present invention comprises toner base particles and secondary agglomerates, wherein the toner base particles comprise a toner material that comprises a colorant and a binding resin, and the secondary agglomerates, which being formed of fine particles, each have a secondary particle diameter of no less than 10 μm.

It is preferred that the secondary agglomerates, which being formed of fine particles, each have a secondary particle diameter of no less than 10 μm, and the number of the secondary agglomerates is 5 to 800 per gram of the toner. The secondary particle diameter of the secondary agglomerates is preferably 10 to 50 μm, and the number of the secondary agglomerates is preferably 5 to 200 per gram of the toner

In cases where the secondary particle diameter of the secondary agglomerates is less than 10 μm, it may be difficult to maintain proper transfer ability and cleaning property for long period, it is likely to cause image fluctuation, or the flowability and charging property of the toner may be unstable.

In cases where the number of the secondary agglomerates is less than 5 per gram of the toner or more than 800 per gram of the toner, it may also be difficult to maintain proper transfer ability and cleaning property for long period, images tend to fluctuate, or the flowability and charging property of the toner is likely to be unstable.

It is preferred that the secondary agglomerates comprise titanium oxide fine particles, each having a primary particle diameter of 80 to 150 nm and being allowable to be hydrophobized, in an amount of no less than 50%, more preferably no less than 70%. In cases where the content of the titanium oxide fine particles having a primary particle diameter of 80 to 150 nm is no less than 50%, transfer ability and cleaning property may be maintained for long period, image fluctuation is unlikely to occur, additives are less likely to be embedded even under stirring the developer at use, and flowability and charging ability are likely to be stable long period.

The primary particle diameter of the fine particles, constituting the secondary agglomerates, may be measured, for example, through dispersing the fine particles into water. A preferable example of the measurement device is Nanotruck Particle Size Analyzer (by Nikkiso Co., UPA-EX150). Specifically, a mixture liquid 0.5 ml of an electrolyte of Isoton II (by Beckman Coulter Co.) and a dispersant of 10% by mass Emulgen 109P electrolyte (by Kao Co., polyoxyethylene laurylether, HLB: 13.6) is dropped into a 100 ml glass beaker, to which an amount of fine particles is added, and the mixture is dispersed for 10 minutes using an ultrasonic dispersing device (W-113MK-II, by Honda Electric Co.). The resulting dispersion is diluted with deionized water, and the mass-average particle diameter is measured by use of the UPA-EX150.

The existence of secondary agglomerates of fine particles having a secondary particle diameter of no less than 10 μm may be determined, for example, in the following way. A toner is made to adhere onto a conductive double-stick tape, to which platinum is vapor-deposited as required, and is observed by a scanning electron microscope (by Hitachi, Ltd., S-4200). The particle images are observed under a magnification of 1000×. The secondary agglomerates may be easily confirmed from the shape through enlarging the magnification of the particle image in question.

The particle size may be determined through measuring the diameter of the secondary agglomerates. In cases where the shape of the secondary agglomerate is far from sphere, the longest diameter is deemed as the secondary particle diameter.

The number or content of the secondary agglomerates, having a secondary particle diameter of no less than 10 μm, may be determined, for example, by way of preparing an enclosed cage of screen material of 635 mesh, in which the circular-mesh diameter being 24 mm and the thickness being 7 mm, and two circular meshes are disposed oppositely.

A toner is weighed into the cage screen in an amount of 0.2 g. The toner is spread evenly over the mesh, the enclosed cage is disposed horizontally, the lower side of the enclosed cage is sucked, and the secondary agglomerates are sieved. An air suction of a toner cleaner (CV-TN96, by Hitachi Ltd.) is disposed near one of two cylinder faces, and arranged to suck near the cylinder face at a suction pressure of 5 mmHg while adjusting the pressure using a transformer, and also air is blown at the height 160 mm from another cylinder face at a blowing pressure of 0.2 MPa for 30 seconds, thereby to remove the toner within the cage screen. Finally, air aspiration is carried out by the toner cleaner at a suction pressure of 20 mmHg to remove the toner. The residual matter remaining on the screen is observed by a digital microscope (Keyence VHX-100) at a magnification of 150×, and the number of secondary agglomerates on the screen is counted. These operations are carried out for 20 view fields and the number “n” of secondary agglomerates is counted with respect to above 10 μm in the view fields remaining on the screen. The number of the secondary agglomerates, having a secondary particle diameter of no less than 10 μm, per 0.2 g of the toner may be determined from the following equation: n×(4.5 cm²/20×Va), in which Va is the actual area of one image taken by the digital microscope, and 4.5 cm² corresponds the mesh size.

It is preferred that the fine particles comprise smaller-diameter particles each having a primary particle diameter of 1 to 30 nm and larger-diameter particles each having a primary particle diameter of 30 to 200 nm.

It is preferred that the smaller-diameter particles are of titanium oxide, silica, metal salts of fatty acids such as zinc stearate and aluminum stearate; metal oxides such as titania, alumina, tin oxide and antimony oxide; or hydrophobized products thereof. It is also preferred that the larger-diameter particles are of titanium oxide, silica, metal salts of fatty acids such as zinc stearate and aluminum stearate; metal oxides such as titania, alumina, tin oxide and antimony oxide; or hydrophobized products thereof.

In the present invention, at least two species of fine particles with different ingredients may bring about maintaining properly the cleaning property and transfer ability since tone-rotating motion may be suppressed and excessive-toner packing may be prevented even the toner shape is substantially spherical. In addition, selective embedding of lower-diameter fine particles into the toner may be prevented even under stirring the developer at use, thus the flowability may be maintained for long period. When the primary particle diameter of the larger-diameter particles is below 30 nm, the effect to suppress the tone-rotating motion may be insufficient and the toner easily gets packing, consequently causing transfer fluctuation.

On the other hand, when the primary particle diameter of the larger-diameter particles is above 200 nm, the fine particles tend to separate, possibly changing the flowability with time. When the primary particle diameter of the smaller-diameter particles is above 30 nm, the flowability is likely to be poor, resulting possibly in unstable toner supply.

Among the two species of these fine particles, the larger-diameter particles tend to provide less effect on the toner flowability. For example, when an amount of the larger-diameter particles is added to an equivalent mixture of smaller-diameter particles and larger-diameter particles, the flowability may be enhanced remarkably. However, the toner solely containing the smaller-diameter particles tends to decrease the flowability with time due to embedding or burial of additives into the toner.

On the contrary, an addition of larger-diameter particles may suppress the flowability decrease with time; however, the larger-diameter particles often cause separation from the toner during stirring the developer, or mixing of the larger-diameter particles with the toner induces an improper deposition of the larger-diameter particles onto the toner, thus the improvement of the transfer fluctuation is insufficient even though the improvement may appear compared to the mere smaller-diameter particles. In cases where images are formed with different image areas in particular, the transfer property changes depending on the stirring period of the developer, residual period of the toner in the developer. This is because that the larger-diameter particles is gradually embedded into the toner similarly as the smaller-diameter particles, consequently, the larger-diameter particles disposed uniformly of the toner surface are unevenly-distributed, and accumulated on minor irregular portions on toner the toner surface, which preventing the effects of the larger-diameter particles.

In accordance with the present invention, inclusion of small amount of secondary agglomerates derived from the larger-diameter particles may make possible to enhance transfer stability still more, by virtue of fresh larger-diameter particles supply to the toner under stirring the toner at use. The agglomerates of the larger-diameter particles in the toner are gradually loosened with the period of stirring developer, and are deposited on the toner surface. Consequently, fine-particle ingredients are freshly supplied into the toner even though larger-diameter particles are slightly embedded, toner flowability changes, or the larger-diameter particles lose the effect to express flowability, as a result, the transfer ability may be maintained, and images may be formed uniformly regardless of the image areas. The size of the agglomerate is preferably 10 μm or more, which affords easy cleaning such as blade cleaning processes for the cleaning of the agglomerates deposited on photoconductors at developing, and thus charging members may be appropriately used without pollution.

The fine particles may be those utilized for enhancing flowability or charging ability in the art; examples thereof include, in addition to oxide fine particles, fine particles of inorganic materials and hydrophobized products thereof.

The fine particles may be properly selected from conventional ones depending on the application; examples thereof include metal salts of fatty acids such as zinc stearate and aluminum stearate; metal oxides such as silica, titanium oxide, alumina, tin oxide and antimony oxide, hydrophobized products thereof, and fluoropolymers. Among these, particularly preferable are silica particles, hydrophobized silica particles, titanium oxide particles, hydrophobized titanium oxide particles, alumina particles and hydrophobized alumina particles.

The silica fine particles may be those commercially available; examples thereof include HDK H2000, HDK H2000/4, HDK H2050EP, HVK21 and HDK H1303 (by Hoechst Co.); R972, R974, RX200, RY200, R202, R805 and R812 (Nippon Aerosil Co.).

The titanium oxide fine particles may be those commercially available; examples thereof include P-25 (by Nippon Aerosil Co.); STT-30, STT-65C-S (by Titan Kogyo K. K.); TAF-140 (by Fuji Titanium Industry Co.); MT-150W, MT-500B, MT-600B and MT-150A (by Tayca Co.).

The hydrophobized titanium oxide fine particles may be those commercially available; examples thereof include T-805 (by Nippon Aerosil Co.); STT-30A and STT-65S-S (by Titan Kogyo K.K.); TAF-500T and TAF-1500T (by Fuji Titanium Industry Co.); MT-100S and MT-100T (by Tayca Co.); IT-S (Ishihara Sangyo Kaisha Ltd.).

The hydrophobized oxide fine particles such as of silica, titanium oxide or alumina fine particles may be produced through treating hydrophilic particles with silane coupling agents such as methyl trimethoxy silane, methyl triethoxy silane or octyl trimethoxy silane. Oxide fine particles or inorganic fine particles may also be favorably employed, in which those fine particles are treated with silicone oil while heating as requires.

Examples of silicone oil include dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy-polyether modified silicone oil, phenol-modified silicone oil, carboxyl-modified silicone oil, mercaptol-modified silicone oil, acryl-modified silicone oil, methacryl-modified silicone oil, and α-methylstyrene-modified silicone oil.

Examples of inorganic fine particles include silica, alumina, titanium oxide, barium titanate, magnesium titanate, calcium titanate, strontium titanate, iron oxide, copper oxide, zinc oxide, tin oxide, quartz sand, clay, mica, silicic pyroclastic rock, diatomaceous earth, chromic oxide, cerium oxide, iron oxide red, antimony trioxide, magnesium oxide, zirconium oxide, barium sulfate, barium carbonate, calcium carbonate, silicon carbide and silicon nitride. Among these, silica and titanium dioxide are especially preferable. The amount of the organic fine particles is preferably 0.1 to 5% by mass based on the toner, more preferably 0.3 to 3% by mass.

Examples of other polymer fine particles include those of polystyrenes, methacrylate copolymers or acrylate copolymers produced through soap-free emulsion, suspension or dispersion polymerization; polycondensation products such as silicones, benzoguanamine and nylon; and polymer particles of thermosetting resins.

These fine particles may be disposed on the surface of toner base particles through conventional dry or wet processes for external addition.

The production process and materials of the toner according to the present invention may be properly selected depending on the application. Preferably, the toner is of spherical shape and smaller diameters so as to form highly precise and fine images. Such a toner may be produced through milling and classifying processes; or suspension polymerization, emulsification polymerization or polymer suspension processes in which oil phase is emulsified, suspended or aggregated in an aqueous medium to form toner base particles.

The milling and classifying processes produce toner base particles through melting-compounding, milling and classifying toner raw materials. In the milling and classifying process, the shape of toner base particles may be controlled by way of applying mechanical impact onto the resulting toner base particles so as to adjust the average circularity of toner into 0.97 to 1.0. The mechanical impact may be applied, for example, onto the toner base particles by use of such devices as Hybritizer and Mechanofusion.

In the suspension polymerization processes described above, oil-soluble polymerization initiators, colorants, release agents, etc. are dispersed in oil-soluble polymerization initiators and polymerizable monomers, and then emulsified and dispersed in aqueous media containing surfactants or other solid dispersants by way of emulsion processes described later. After forming particles through polymerization reaction, the inorganic fine particles may be disposed on the particle surface of the inventive toner by wet processes. Preferably, the wet processes are performed after excess surfactants are rinsed and removed.

Examples of polymerizable monomer include monomer acids such as acrylic acid, methacrylic acid, α-cyanoacrylic acid, α-cyanomethacrylic acid, itaconic acid, crotonic acid, fumaric acid, maleic acid, maleic anhydride, or the like; acrylamide, methacrylamide, diacetone acrylamide, and methyloyl compounds thereof; acrylate, methacrylate having amine group such as vinylpyridine, vinylpyrrolidone, vinylimidazole, ethyleneimine, dimethylaminoethyl methacrylate, or the like. Using a part of above monomers may allow introducing functional groups onto the surface of toner particles.

Furthermore, dispersants may be adsorbed on the particle surface and thus functional groups may also be introduced by appropriately selecting dispersants having an acid group or basic group.

The emulsion polymerization processes emulsify polymerizable monomers in water using water-soluble polymerization initiators and surfactants under conventional processing to prepare latexes. Separately, dispersions are prepared that contain colorants, release agents, etc. in aqueous media. The resulting latex and dispersion are mixed, followed by agglomerating the mixture to a toner size, and heating-melting to produce a toner. Then the inorganic fine particles may be disposed in a wet processing. The functional group may be introduced into the surface of toner particles by using same monomers used as latex for suspension polymerization processes.

Among these toners, the toner in the present invention is preferably those produced by way of fusing and dispersing toner material containing active hydrogen group-containing compounds and reactive polymers thereof in an organic solvent, the dispersion is regulated by emulsification and dispersion of toner solution into an aqueous medium, the adhesive base material is reduced into particles by reaction between active hydrogen group-containing compounds and reactive polymers thereof in the aqueous medium and the organic solvent is eliminated, in view of wide selectability for resins, fixing ability at lower temperatures, superior granulating ability, and easy control for particle diameter, particle size distribution and particle shape.

The toner material contains at least an adhesive base material, which being produced by reaction of an active hydrogen group-containing compound, a polymer capable of reacting with the active hydrogen group-containing compound, a binding resin, a charge control agent and a colorant, and also other optional ingredients such as resin fine particles and a release agent as required.

Adhesive Base Material

The adhesive base material may adhere to recording media such as paper, and contains at least an adhesive polymer produced by reaction of an active hydrogen-containing compound and a polymer capable of reacting with the active hydrogen group-containing compound, and also optional binding resins selected from conventional ones.

The average molecular mass of the adhesive base material may be properly selected depending on the application; preferably, the average molecular mass is no less than 1000, more preferably 2000 to 10,000,000, and most preferably 3000 to 1,000,000. In cases where the average molecular mass is less than 1000, hot offset resistance may be inferior.

The storage modulus of the adhesive base material may be properly selected depending on the application. For example, the temperature TG′, at which the storage modulus being 10,000 dyne/cm² at 20 Hz, is typically 100° C. or more and preferably from 110° C. to 200° C. In cases where the temperature TG′ is less than 100° C., the hot offset resistance may be inferior.

The viscosity of the adhesive base material may be properly selected depending on the application. The temperature Tη, at which the viscosity being 10,000 poises at 20 Hz, is typically 180° C. or less, preferably 90° C. to 160° C. In cases where the temperature (Tη) is higher than 180° C., the low-temperature fixing ability may be inferior.

As such, from the viewpoint of simultaneous pursuit of the hot offset resistance and the low-temperature fixing ability, the temperature TG′ is preferably higher than the temperature Tη. Specifically, the difference between TG′ and Tη is preferably no less than 0° C., and more preferably no less than 10° C., and most preferably no less than 20° C. The higher is the difference, the better will be the effect.

From the viewpoint of simultaneous pursuit of hot offset resistance and the low-temperature fixing ability, the difference between TG′ and Tη is preferably from 0° C. to 100° C., more preferably from 10° C. to 90° C., and most preferably from 20° C. to 80° C.

The adhesive base material may be properly selected depending on the application; preferable examples thereof are polyester resins. The polyether resins may be properly selected depending on the application; preferable examples thereof are urea-modified polyester resins in particular.

The urea-modified polyester resin may be produced by reaction of amines (B) as an active hydrogen group-containing compound, and isocyanate group-containing polyester prepolymer (A) as a polymer reactive with the active hydrogen group-containing compound in the aqueous medium.

The urea-modified polyester resin may include a urethane bond in addition to a urea bond. The molar ratio of the urea bond to the urethane bond is preferably 100/0 to 10/90, more preferably 80/20 to 20/80, and most preferably 60/40 to 30/70. In cases where the molar ratio of the urea bond is less than 10%, the hot offset resistance may be inferior.

Preferable examples of the urea-modified polyester are preferably the following (1) to (10): (1) a mixture of (i) polycondensation product of bisphenol A ethyleneoxide two-mole adduct and isophthalic acid, and (ii) urea-modified polyester prepolymer which is obtained by reacting isophorone disocyanate with a polycondensation product of bisphenol A ethyleneoxide two-mole adduct and isophtalic acid, and modifying with isophorone diamine; (2) a mixture of (iii) a polycondensation product of bisphenol A ethyleneoxide two-mole adduct and terephthalic acid, and (ii) urea-modified polyester prepolymer which is obtained by reacting isophorone disocyanate with a polycondensation product of bisphenol A ethyleneoxide two-mole adduct and terephthalic acid, and modifying with isophorone diamine; (3) a mixture of (iv) polycondensation product of bisphenol A ethyleneoxide two-mole adduct, bisphenol A propyleneoxide two-mole adduct and terephthalic acid, and (v) urea-modified polyester prepolymer which is obtained by reacting isophorone disocyanate with polycondensation product of bisphenol A ethyleneoxide two-mole adduct, bisphenol A propyleneoxide two-mole adduct and terephthalic acid, and modifying with isophorone diamine; (4) a mixture of (vi) polycondensation product of bisphenol A propyleneoxide two-mole adduct and terephthalic acid, and (v) urea-modified polyester prepolymer which is obtained by reacting isophorone disocyanate with polycondensation product of bisphenol A ethyleneoxide two-mole adduct, bisphenol A propyleneoxide two-mole adduct and terephthalic acid, and modifying with isophorone diamine; (5) a mixture of (iii) polycondensation product of bisphenol A ethyleneoxide two-mole adduct and terephthalic acid, and (vi) urea-modified polyester prepolymer which is obtained by reacting isophorone disocyanate with polycondensation product of bisphenol A ethyleneoxide two-mole adduct and terephthalic acid, and modifying with hexamethylene diamine; (6) a mixture of (iv) polycondensation product of bisphenol A ethyleneoxide two-mole adduct, a bisphenol A propyleneoxide two-mole adduct and terephthalic acid, and (vi) urea-modified polyester prepolymer which is obtained by reacting isophorone disocyanate with polycondensation product of bisphenol A ethyleneoxide two-mole adduct and terephthalic acid, and modifying with hexamethylene diamine; (7) a mixture of (iii) polycondensation product of bisphenol A ethyleneoxide two-mole adduct and terephthalic acid, and (vii) urea-modified polyester prepolymer which is obtained by reacting isophorone disocyanate with polycondensation product of bisphenol A ethyleneoxide two-mole adduct and terephthalic acid, and modifying with ethylene diamine; (8) a mixture of (i) polycondensation product of bisphenol A ethyleneoxide two-mole adduct and isophthalic acid, and (viii) urea-modified polyester prepolymer which is obtained by reacting diphenylmethane disocyanate with polycondensation product of bisphenol A ethyleneoxide two-mole adduct and isophthalic acid, and modifying with hexamethylene diamine; (9) a mixture of (iv) polycondensation is product of bisphenol A ethyleneoxide two-mole adduct, bisphenol A propyleneoxide two-mole adduct, terephthalic acid and dodecenylsuccinic anhydride, and (ix) urea-modified polyester prepolymer which is obtained by reacting diphenylmethane disocyanate with polycondensation product of bisphenol A ethyleneoxide two-mole adduct, bisphenol A propyleneoxide two-mole adduct, terephthalic acid and dodecenylsuccinic anhydride, and modifying with hexamethylene diamine; (10) a mixture of (i) polycondensation product of bisphenol A ethyleneoxide two-mole adduct and isophthalic acid, and (x) urea-modified polyester prepolymer which is obtained by reacting toluene disocyanate with polycondensation product of bisphenol A ethyleneoxide two-mole adduct and isophthalic acid, and modifying with hexamethylene diamine.

Active Hydrogen Group-Containing Compound

The active hydrogen group-containing compound functions as an elongation initiator or crosslinking agent in elongation reaction or crosslinking reaction with the polymer reactive with the active hydrogen group-containing compound in aqueous media.

The active hydrogen group-containing compounds may be anything as long as containing active hydrogen group, and may be selected properly depending on the application. For example, in cases where the polymer reactive with the active hydrogen group-containing compounds is an isocyanate group-containing polyester prepolymer (A), amines (B) are preferable from the viewpoint of ability to increase molecular mass by the elongation reaction or crosslinking reaction.

The active hydrogen group may be properly selected depending on the application; examples thereof include hydroxyl group such as alcoholic hydroxyl group and phenolic hydroxyl group, amino group, carboxyl group and mercapto group. These may be used alone or in combination. Among these, alcoholic hydroxyl group is especially preferable.

The amines (B) may be properly selected depending on the application; examples thereof include diamines (B1), polyamines of trivalent or higher (B2), amino alcohols (B3), amino mercaptans (B4), amino acids (B5) and blocked ones of amino groups (B1) to (B5). These may be used alone or in combination. Among these, diamines (B1), and mixtures of diamines (B1) and a small amount of polyamines of trivalent or higher (B2) are especially preferable.

Examples of diamines (B1) include aromatic diamines, alicyclic diamines and aliphatic diamines. Examples of aromatic diamine are phenylene diamine, diethyltoluene diamine and 4,4′-diaminophenylmethane. Examples of alicyclic diamine include 4,4′-diamino-3,3′-dimethyldicycrohexylmethane, diamine cyclohexane and isophorone diamine. Examples of aliphatic diamine include ethylene diamine, tetramethylene diamine and hexamethylene diamine.

Examples of polyamines of trivalent or higher (B2) include diethylene triamine and triethylene tetramine. Examples of amino alcohols (B3) include ethanolamine and hydroxyethylaniline.

Examples of amino mercaptans (B4) include aminoethylmercaptan and aminopropylmercaptan. Examples of amino acids (B5) include amino propionic acid and amino capric acid.

Examples of compounds (B6) with blocked amino groups (B1) to (B5) include ketimine compounds and oxazoline compounds, obtained from amines (B1) to (B5), and ketones such as acetone, methylethylketone and methylbutylketone.

A reaction terminator may be used to stop the elongation reaction, crosslinking reaction, or the like between the active hydrogen group-containing compound and the polymer reactive with the compound. The reaction terminator is preferably employed for controlling the molecular mass of adhesive base material within a preferable range. Examples of reaction terminator include monoamines such as diethylamine, dibutylamine, butylamine and laurylamine, and also block compounds thereof such as ketimine compounds.

The mixture ratio of amines (B) and the isocyanate group-containing prepolymer (A), in terms of mixture equivalent ratio of isocyanate group [NCO] in the isocyanate group-containing prepolymer (A) and amino group [NHx ] in the amines (B), [NCO]/[NHx], is preferably from 1/3 to 3/1, more preferably from 1/2 to 2/1 and most preferably from 1/1.5 to 1.5/1. When the mixture equivalent ratio [NCO]/[NHx] is less than 1/3, the low-temperature fixing ability may deteriorate, and when it is more than 3/1, the molecular mass of urea-modified polyester becomes low, possibly imparing the hot offset resistance.

Polymer Reactive with Active Hydrogen Group-Containing Compound

The polymer reactive with the active hydrogen group-containing compound (hereinafter sometimes referred to as “prepolymer”” may be anything as long as containing at least a site reactive with the active hydrogen group-containing compound; examples thereof include polyol resins, polyacrylic resins, polyester resins, epoxy resins and derivatives thereof. These may be used alone or in combination. Among these, polyester resins are especially preferable from the view point of higher flowability at melting condition and transparency.

The site of the prepolymer reactive with the active hydrogen group-containing compound may be properly selected from publicly known substituents depending on the application; examples thereof include isocyanate group, epoxy group, carboxylic acid, acid chloride group, and the like. These may be used alone or in combination.

Among these, isocyanate group is especially preferable. Among the prepolymers described above, urea-bond-forming group containing polyester resins (RMPE) are especially preferable, in view of controllable molecular mass of their polymers, oilless-fixing ability of dry toner at low temperatures, in particular favorable releasing and fixing abilities even without release-oil-coating system for fixing-heating media.

The urea-bond-forming group is exemplified by isocyanate group. In cases where the urea-bond-forming group of the urea-bond-forming group containing polyester resins is isocyanate group, the urea-bond-forming group containing polyester resins are preferably exemplified by the isocyanate group-containing polyester prepolymers (A).

The isocyanate group-containing polyester prepolymer (A) may be properly selected depending on the application, is exemplified by a polycondensate of polyol (PO) and polycarboxylic acid (PC), and may be a reactant of the active hydrogen group-containing polyester resin and a polyisocyanate (PIC).

The polyol (PO) may be properly selected depending on the application; examples thereof include diols (DIO), polyols of trivalent or higher, mixtures of diols and polyols of trivalent or higher, and the like. These may be used alone or in combination. Among these, preferable are diols (DIO) themselves and mixtures of diols (DIO) and a small amount of polyols of trivalent or higher.

Examples of diols (DIO) include alkylene glycols, alkylene ether glycols, alicyclic diols, alkylene oxide adducts of alicyclic diol, bisphenols, alkylene oxide adducts of bisphenols, and the like.

The alkylene glycols of carbon number 2 to 12 are preferable; examples thereof include ethylene glycol, 1,2-propylene glycol, 1,3-propylene glycol, 1,4-butanediol, and 1,6-hexanediol. Examples of the alkylene ether glycols include diethylene glycol, triethylene glycol, dipropylene glycol, polyethylene glycol, polypropylene glycol, and polytetramethylene ether glycol. Examples of the alicyclic diols include 1,4-cyclohexane dimethanol and hydrogenated bisphenol A. Examples of the alkylene oxide adducts of the alicyclic diols include cycloaliphatic diols added with alkylene oxides such as ethylene oxide, propylene oxide, and butylene oxide. Examples of the bisphenols include bispheonol A, bisphenol F, and bisphenol S. The alkylene oxide adducts of bisphenols include bisphenols added with alkylene oxides such as ethylene oxide, propylene oxide, and butylene oxide. Among these, preferable are alkylene glycols of carbon number 2 to 12 and alkylene oxide adducts of bisphenols; particularly preferable are alkylene oxide adducts of bisphenols and combination of alkylene oxide adducts of bisphenols and alkylene glycols of carbon number 2 to 12.

The polyols of trivalent or higher are preferably those having a valency of 3 to 8 or higher; examples thereof are polyvalent aliphatic alcohols of trivalent or higher, polyphenols of trivalent or higher, alkylene oxide adducts of polyphenols of trivalent or higher, and the like.

Examples of polyols of trivalent or higher (TO) include polyaliphatic alcohols of trivalent or higher, such as glycerine, trimethylol ethane, trimethylol propane, pentaerythritol, sorbitol, and the like. Examples of polyphenols of trivalent or higher include trisphenol PA, phenol novolac, cresol novolac, and like. The alkylene oxide adducts of above-mentioned polyphenols of trivalent or higher include ethylene oxide, propylene oxide, butylene oxide, and the like.

The mass ratio, DIO:TO, of diol (DIO) and polyol of trivalent or higher (TO) is preferably 100:0.01 to 100:10 and more preferably 100:0.01 to 100:1.

Polycarboxylic acid (PC) may be properly selected depending on the application; examples thereof include dicarboxylic acids (DIC), polycarboxylic acids of trivalent or higher (TC), combinations of dicarboxylic acids and polycarboxylic acids of trivalent or higher, and the like.

These may be used alone or in combination. Among these, dicarboxylic acids themselves, or combinations of DICs and a small amount of polycarboxylic acids of trivalent or higher are preferable.

Examples of dicarboxylic acid include alkylene dicarboxylic acids, alkenylene dicarboxylic acids, aromatic dicarboxylic acids, and the like.

Examples of alkylene dicarboxylic acid include succinic acid, adipic acid, sebacic acid, and the like. The alkenylene dicarboxylic acids are preferably of carbon number 4 to 20; examples thereof include maleic acid, fumaric acid, and the like. The aromatic dicarboxylic acids are preferably of carbon number 8 to 20; examples thereof include phthalic acid, isophthalic acid, terephthalic acid, naphthalendicarboxylic acid, and the like.

Among these, preferable are alkenylene dicarboxylic acids of carbon number 4 to 20 and aromatic dicarboxylic acids of carbon number 8 to 20.

The polycarboxylic acids (TO) of trivalent or higher preferably have a valence of 3 to 8 or more, and which are exemplified by aromatic polycarboxylic acids.

The aromatic polycarboxylic acids are preferably of carbon number 9 to 20; examples thereof include trimellitic acid, pyromellitic acid, and the like.

The polycarboxylic acids may be acid anhydrides or lower alkyl esters selected from dicarboxylic acids, polycarboxylic acids of trivalent or higher and combinations of dicarboxylic acid and polycarboxylic acid of trivalent or higher. Examples of lower alkyl ester include methyl esters, ethyl esters, isopropyl esters, and the like.

The mass ratio, DIC:TC, in combinations of dicarboxylic acid (DIC) and polycarboxylic acid of trivalent or higher (TC) may be properly selected depending on the application; the mass ratio is preferably 100:0.01 to 100:10 and more preferably 100:0.01 to 100:1.

The mass ratio of polyol (PO) and polycarboxylic acid (PC) at the polycondensation reaction may be properly selected depending on the application; for example, the equivalent ratio, [OH]/[COOH], of hydroxyl group [OH] of polyol (PO) and carboxyl group [COOH] of polycarboxylic acid (PC) is preferably 2/1 to 1/1 and more preferably 1.5/1 to 1/1, and most preferably 1.3/1 to 1.02/1.

The content of polyol (PO) in the isocyanate group-containing polyester prepolymer (A) may be properly selected depending on the application; preferably, the content is 0.5% by mass to 40% by mass, more preferably 1% by mass to 30% by mass and most preferably 2% by mass to 20% by mass.

In cases where the content is less than 0.5% by mass, the hot offset resistance may be deteriorated, making difficult to pursue high-temperature preservability and low-temperature fixing ability at the same time. In cases where the content is more than 40% by mass, low-temperature fixing ability may be deteriorated.

The polyisocyanates (PICs) may be properly selected depending on the application; examples thereof include aliphatic polyisocyanates, alicyclic polyisocyanates, aromatic diisocyanate, aroma-aliphatic diisocyanates, isocyanurates, phenol derivatives thereof, and derivative compounds blocked with oxime or caprolactam.

Examples of aliphatic polyisocyanates include tetramethylene diisocyanate, hexamethylene diisocyanate, 2,6-diisocyanate methyl caproate, octamethylene diisocyanate, decamethylene diisocyanate, dodecamethylene diisocyanate, tetradecamethylene diisocyanate, torimethylhexane diisocyanate, tetramethyhexane diisocyanate, and the like. Examples of alicyclic polyisocyanates include isophorone diisocyanate, cyclohexylmethane diisocyanate, and the like. Examples of aromatic diisocyanates include trilene diisocyanate, diphenylmethane diisocyanate, 1,5-naphtylene diisocyanate, diphenylene-4,4′-diisocyanate, 4,4′-diisocyanato-3,3′-dimethyldiphenyl, 3-methyldiphenylmethane-4,4′-diisocyanate, diphenylether-4,4′-diisocyanate, and the like. Examples of aromatic aliphatic diisocyanates include α, α,α′, α′-tetramethylxylylene diisocyanate, and the like. Examples of isocyanurates include tris-isocyanatoalkyl-isocyanurate, toriisocyanatocycloalkyl-isocyanurate, and the like. These may be used alone or in combination.

Preferably, the equivalent mixing ratio, [NCO]/[OH], of isocyanate group [NCO] of polyisocyanate (PIC) to hydrogen group [OH] of active hydrogen group-containing polyester resin such as hydrogen group-containing polyester resin at the reaction, is 5/1 to 1/1, more preferably 4/1 to 1.2/1 and most preferably 3/1 to 1.5/1.

When the value of isocyanate group [NCO] is more than 5, the low-temperature fixing ability may be deteriorated, and when less than 1, the offset resistance may be deteriorated.

The content of polyisocyanate (PIC) in the isocyanate group-containing polyester prepolymer (A) may be properly selected depending on the application. Preferably, the content is 0.5% by mass to 40% by mass, more preferably 1% by mass to 30% by mass, and most preferably 2% by mass to 20% by mass.

When the content is less than 0.5% by mass, the hot offset resistance may be deteriorated, making difficult to pursue the high-temperature preservability and the low-temperature fixing ability simultaneously, and when the content is more than 40% by mass, the low-temperature fixing ability may be deteriorated.

The average number of isocyanate groups contained in one molecule of the isocyanate group-containing polyester prepolymer (A) is preferably 1 or more, more preferably 1.2 to 5, and most preferably 1.5 to 4.

When the average number of isocyanate groups is less than 1, the molecular mass of polyester resin (RMPE) modified with the urea-bond-formation group comes to lower and the hot offset resistance may be deteriorated.

The average molecular mass (Mw) of the polymer reactive with the active hydrogen group-containing compound, in terms of molecular mass distribution by Gel permeation chromatography (GPC) of tetrahydrofuran (THF) soluble content, is preferably 1000 to 30,000, more preferably 1500 to 15,000. When the average molecular mass (Mw) is less than 1000, the high-temperature preservability may be deteriorated and when more than 30,000, the low-temperature fixing ability may be deteriorated.

The molecular mass distribution by Gel permeation chromatography (GPC), for example, may be measured as follow.

That is, the column is firstly stabilized inside the heat chamber of 40° C. At this temperature, tetrahydrofuran (THF) as a column solvent is flowed at a flow rate of 1 ml/minute, and 50 to 200 μl of sample resin in THF is injected at a concentration of 0.05% by mass to 0.6% by mass, then the measurement is carried out. In the measurement of molecular mass of the sample, a molecular mass distribution of the sample is calculated from relationship between logarithm values of the analytical curve made from several mono-disperse polystyrene standard samples and counted numbers. It is preferred that the standard polystyrene samples for making analytical curves are preferably ones with a molecular mass of 6×10², 2.1×10², 4×10², 1.75×10⁴, 1.1×10⁵, 3.9×10⁵, 8.6×10⁵, 2×10⁶ and 48×10⁶ (by Pressure Chemical Co., or Tosoh Co.) and at least approximately 10 pieces of the standard polystyrene sample is used. A refractive index (RI) detector may be used for the detector.

Binding Resin

The binding resin may be properly selected depending on the application; examples thereof are polyester resins, preferable are unmodified polyester resins in particular. The unmodified polyester resins may improve the low-temperature fixing ability and glossiness.

Examples of the unmodified polyester resin include those similar to urea-bond-forming group-containing polyester resin such as polycondensation products of polyol (PO) and polycarboxylic acid (PC), and the like. The unmodified polyester resin which is partially compatible with the urea-bond-forming group-containing polyester resin (RMPE), that is, having similar structures that are compatible to each other, is preferable in terms of low-temperature fixing ability and the hot offset resistance.

The mass-average molecular mass (Mw) of unmodified polyester resin, in terms of the molecular mass distribution by GPC (Gel permeation chromatography) of tetrahydrofuran (THF) soluble content, is preferably 1000 to 30,000 and more preferably 1500 to 15,000. The content, of which the average molecular mass (Mw) being less than 1000, should be 8% by mass to 28% by mass in order to prevent deterioration of high-temperature preservability. When the mass-average molecular mass (Mw) is more than 30,000, the low-temperature fixing ability may be deteriorated.

The glass transition temperature of the unmodified polyester resin is typically 30° C. to 70° C., preferably 35° C. to 70° C., more preferably 35° C. to 50° C. and most preferably 35° C. to 45° C. In cases where the glass transition temperature being less than 30° C., the high-temperature preservability of the toner may be deteriorated and when more than 70° C., the low-temperature fixing ability may be insufficient.

The hydroxyl group value of unmodified polyester resin is preferably 5 mgKOH/g or more, more preferably 10 mgKOH/g to 120 mgKOH/g and most preferably 20 mgKOH/g to 80 mgKOH/g. When the hydroxyl group value is less than 5 mgKOH/g, it is difficult to pursue the high-temperature preservability and the low-temperature fixing ability simultaneously.

The acid value of unmodified polyester resin is preferably 1.0 mgKOH/g to 50.0 mgKOH/g, more preferably 1.0 mgKOH/g to 45.0 mgKOH/g and most preferably 15.0 mgKOH/g to 45.0 mgKOH/g. The toner may be easily charged negatively through applying the acid values to the toner.

When the unmodified polyester resin is contained in the toner, the mass ratio, RMPE/PE, of the urea-bond-forming group-containing polyester resin (RMPE) to the unmodified polyester resin (PE) is preferably 5/95 to 25/75, and more preferably 10/90 to 25/75.

When the amount of unmodified polyester resin is more than 95 in the mixture, the hot offset resistance may be deteriorated, making difficult to pursue the high-temperature preservability and the low-temperature fixing ability simultaneously, and when the amount is less than 25 in the mixture, the glossiness may be deteriorated.

The content of unmodified polyester resin in the binder resin, for example, is preferably 50% by mass to 100% by mass, more preferably 70% by mass to 95% by mass, and most preferably 80% by mass to 90% by mass. When the content is less than 50% by mass, the low-temperature fixing ability or the image glossiness may be deteriorated.

Other Ingredients

The other ingredients may be properly selected depending on the application; examples thereof include colorants, release agents, charge control agents, inorganic particles, flowability enhancers, cleaning improvers, magnetic materials, metal soaps, and the like.

The colorants may be properly selected depending on the application; examples thereof include carbon blacks, nigrosine dyes, iron black, Naphthol Yellow S, Hansa Yellow (10G, 5G, G), cadmium yellow, yellow iron oxide, yellow ocher, chrome yellow, Titan Yellow, Polyazo Yellow, Oil Yellow, Hansa Yellow (GR, A, RN, R), Pigment Yellow L, Benzidine Yellow (G, GR), Permanent Yellow (NCG), Vulcan Fast Yellow (5G, R), Tartrazine Lake, Quinoline Yellow Lake, anthracene yellow BGL, isoindolinone yellow, colcothar, red lead oxide, lead red, cadmium red, cadmium mercury red, antimony red, Permanent Red 4R, Para Red, Fire Red, parachlororthonitroaniline red, Lithol Fast Scarlet G, Brilliant Fast Scarlet, Brilliant Carmine BS, Permanent Red (F2R, F4R, FRL, FRLL, F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Hello Bordeaux BL, Bordeaux 10B, BON Maroon Light, BON Maroon Medium, eosine lake, Rhodamine Lake B, Rhodamine Lake Y, Alizarine Lake, Thioindigo Red B, Thioindigo Maroon, Oil Red, quinacridone red, Pyrazolone Red, Polyazo Red, Chrome Vermilion, Benzidine Orange, Perynone Orange, Oil Orange, cobalt blue, cerulean blue, Alkali Blue Lake, Peacock Blue Lake, Victoria Blue Lake, metal-free phthalocyanine blue, Phthalocyanine Blue, Fast Sky Blue, Indanthrene Blue (RS, BC), indigo, ultramarine, Prussian blue, Anthraquinone Blue, Fast Violet B, Methyl Violet Lake, cobalt violet, manganese violet, dioxazine violet, Anthraquinone Violet, chrome green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc white, and lithopone, and the like. These may be used alone or in combination.

The content of the colorant in the toner may be properly selected depending on the application; preferably, the content is 1% by mass to 15% by mass, and more preferably 3% by mass to 10% by mass. When the content is less than 1% by mass, tinting strength of the colorant is insufficient, and when the content is more than 15% by mass, pigment dispersion is likely to be insufficient in the toner, resulting in degradation of tinting strength or electric properties of the toner.

The colorants may be combined with resins to form masterbatches. Such resins may be properly selected depending on the application; examples thereof include polymers of styrene or substituted styrenes, styrene copolymers, polymethyl methacrylates, polybuthyl methacrylates, polyvinyl chlorides, polyvinyl acetates, polyethylenes, polypropylenes, polyesters, epoxy resins, epoxy polyol resins, polyurethanes, polyamides, polyvinyl butyral, polyacrylic acid resins, rosin, modified rosins, terpene resins, aliphatic or alicyclic hydrocarbon resins, aromatic petroleum resins, chlorinated paraffin, paraffin, and the like. These may be used alone or in combination.

Examples of polymers of styrene or substituted styrenes include polyester resin, polystyrene, poly-p-chlorostyrene, polyvinyl toluene, and the like. Examples of styrene copolymers include styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers, styrene-maleic ester copolymers, and the like

The masterbatches may be obtained by mixing and kneading resins for the masterbatch and a colorant with high shear force. In order to improve interaction between colorant and a resin, an organic solvent may be used. In addition, the “flushing process” in which a wet cake of colorant being applied directly is preferable because drying is unnecessary. In the flushing process, a water-based paste containing colorant and water is mixed and kneaded with the resin and an organic solvent so that the colorant moves towards the resin, and that water and the organic solvent are removed. The materials are preferably mixed and kneaded using a triple roll mill and other high-shear dispersing devices.

The charge control agent may be properly selected depending on the application; preferably, the charge control agent is preferably of ones close to transparent and/or so as to be free from affecting the color tone. Examples of charge control agent include triphenylmethane dyes, molybdic acid chelate pigments, rhodamine dyes, alkoxy amines, quaternary ammonium salts such as fluoride-modified quaternary ammonium salts, alkylamide, phosphoric monomer or compound thereof, tungsten monomer or compounds thereof, fluoride activators, salicylic acid metallic salts, metallic salts of salicylic acid derivative, and the like. These may be used alone or in combination.

The charge control agent may be of commercially available ones. Specific examples thereof include Bontron P-51 of a quaternary ammonium salt, Bontron E-82 of an oxynaphthoic acid metal complex, Bontron E-84 of a salicylic acid metal complrex and Bontron E-89 of a phenol condensate (Orient Chemical Industries, Ltd.); TP-302 and TP-415 of a quaternary ammonium salt molybdenum metal complex (by Hodogaya Chemical Co.); Copy Charge PSY VP2038 of a quaternary ammonium salt, Copy Blue PR of a triphenylmethane derivative and Copy Charge NEG VP2036 and Copy Charge NX VP434 of a quaternary ammonium salt (by Hoechst Ltd.); LRA-901, and LR-147 of a boron metal complex (by Japan Carlit Co., Ltd.); quinacridone, azo pigment, and other high-molecular mass compounds having functional group of sulfonic acid, carboxyl, quaternary ammonium salt, or the like.

The charge control agent may be dissolved and/or dispersed in the toner material after kneading with the masterbatch. The charge control agent may also be added directly at dissolving or dispersing into the organic solvent together with the toner material. In addition, the charge control agent may be added onto the surface of the toner particles after producing the toner particles.

The content of the charge control agent depends on binder resins, external additives, and dispersion processes, preferably, the content of charge control agent is 0.1 part by mass to 10 parts by mass, and more preferably 0.2 part by mass to 5 parts by mass based on 100 parts by mass of the binder resin. When the content is less than 0.1 parts by mass, the charge may be uncontrollable; when the content is more than 10 parts by mass, charging ability of the toner becomes excessively significant, which lessens the effect of charge control agent itself and increases electrostatic attraction force with a developing roller, leading to decrease of developer flowability or image density degradation.

The release agent may be properly selected from conventional ones, and is exemplified by waxes. Examples of wax include carbonyl group-containing waxes, polyolefin waxes, long-chain hydrocarbons, and the like. These may be used alone or in combination. Among these, carbonyl group-containing waxes are preferable.

Examples of carbonyl group-containing wax include polyalkanoic acid esters, polyalkanol esters, polyalkanoic acid amides, polyalkyl amides, dialkyl ketones, and the like. Examples of polyalkanoic esters include carnauba wax, montan wax, trimethylolpropane tribehenate, pentaerythritol tetrabehenate, pentaerythritol diacetate dibehenate, glycerin tribehenate, 1,18-octadecan diol distearate, and the like. Examples of polyalkanol esters include trimellitic tristearate, distearyl maleate, and the like. Examples of polyalkanoic acid amides include behenyl amide and the like. Examples of polyalkyl amides include trimellitic acid tristearyl amide, and the like. Examples of dialkyl ketones include distearyl ketone, and the like. Among these carbonyl group-containing waxes, the polyalkanoic acid esters are particularly preferable.

Examples of polyolefin wax include polyethylene wax, polypropylene wax, and the like. Examples of long-chain hydrocarbon include paraffin wax, Sasol wax, and the like.

The melting point of the release agent may be properly selected depending on the application; preferably, the melting point is 40° C. to 160° C., more preferably 50° C. to 120° C., and most preferably 60° C. to 90° C.

When the melting point is below 40° C., the wax may adversely affect high-temperature preservability; and when the melting point is above 160° C., it is liable to cause cold offset at fixing processes under lower temperatures.

The melt viscosity of the release agent is, measured at the temperature 20° C., higher than the melting point of the wax, preferably 5 cps to 1000 cps, and more preferably 10 cps to 100 cps. In cases where the melt viscosity is less than 5 cps, releasing ability may be deteriorated, and when the melt viscosity is more than 1000 cps, the offset resistance and the low-temperature fixing ability may be improved insufficiently.

The content of the release agent in the toner may be properly selected depending on the application; preferably, the content is 0% by mass to 40% by mass, and more preferably 3% by mass to 30% by mass. When the content is more than 40% by mass, the toner flowability may be deteriorated.

Resin Fine Particles

The resin fine particles may be anything as long as capable of forming an aqueous dispersion in an aqueous medium, and may be selected from conventional resins accordingly. The resin fine particles may be of thermoplastic resins or thermosetting resins; examples thereof include vinyl resins, polyurethane resins, epoxy resins, polyester resins, polyamide resins, polyimide resins, silicone resins, phenol resins, melamine resins, urea resins, aniline resins, ionomer resins, polycarbonate resins, and the like. Among these, vinyl resins are particularly preferable.

These may be used alone or in combination. Among these, the resin fine particles formed of at least one selected from the vinyl resins, polyurethane resins, epoxy resins, and polyester resins are preferable by virtue of easily producing aqueous dispersion of fine spherical resin particles.

The vinyl resins are polymers in which a vinyl monomer is mono- or co-polymerized. Examples of vinyl resins include styrene-(meth)acrylate resins, styrene-butadiene copolymers, (meth)acrylate-acrylic acid ester copolymers, sthrene-acrylonitrile copolymers, styrene-maleic anhydride copolymers, styrene-(meth)acrylate copolymers, and the like.

The resin fine particles may be formed of copolymer containing a monomer having at least two or more unsaturated groups. The monomer having at least two or more unsaturated groups may be selected accordingly. Examples of such monomers include sodium salt of sulfate ester of methacrylic acid ethylene oxide adduct (Eleminol RS-30, by Sanyo Chemical Industries, Ltd.), divinylbenzene, 1,6-hexane-diol acrylate, and the like.

The resin fine particles may be formed through conventional polymerization processes properly selected depending on the application, and are preferably produced into an aqueous dispersion of resin fine particles. Examples of preparation processes of the aqueous dispersion include (1) a direct preparation process of aqueous dispersion of the resin fine particles in which, in the case of the vinyl resin, a vinyl monomer as a raw material is polymerized by suspension-polymerization process, emulsification-polymerization process, seed polymerization process or dispersion-polymerization process; (2) a preparation process of aqueous dispersion of the resin fine particles in which, in the case of the polyaddition and/or condensation resin such as polyester resin, polyurethane resin, or epoxy resin, a precursor (monomer, oligomer or the like) or solvent solution thereof is dispersed in an aqueous medium in the presence of a dispersing agent, and heated or added with a curing agent so as to be cured, thereby producing the aqueous dispersion of the resin fine particles; (3) a preparation process of aqueous dispersion of the resin fine particles in which, in the case of the polyaddition and/or condensation resin such as polyester resin, polyurethane resin, or epoxy resin, a suitably selected emulsifier is dissolved in a precursor (monomer, oligomer or the like) or solvent solution thereof (preferably being liquid, or being liquidized by heating), and then water is added so as to induce phase inversion emulsification, thereby producing the aqueous dispersion of the resin fine particles; (4) a preparation process of aqueous dispersion of the resin fine particles, in which a resin, previously prepared by polymerization process which may be any of addition polymerization, ring-opening polymerization, polyaddition, addition condensation, or condensation polymerization, is pulverized by means of a pulverizing mill such as mechanical rotation-type, jet-type or the like, and classified to obtain resin fine particles, and then the resin fine particles are dispersed in an aqueous medium in the presence of a suitably selected dispersing agent, thereby producing the aqueous dispersion of the resin fine particles; (5) a preparation process of aqueous dispersion of the resin fine particles, in which a resin, previously prepared by a polymerization process which may be any of addition polymerization, ring-opening polymerization, polyaddition, addition condensation or condensation polymerization, is dissolved in a solvent, the resulting resin solution is sprayed in the form of a mist to thereby obtain resin fine particles, and then the resulting resin fine particles are dispersed in an aqueous medium in the presence of a suitably selected dispersing agent, thereby producing the aqueous dispersion of the resin fine particles; (6) a preparation process of aqueous dispersion of the resin fine particles, in which a resin, previously prepared by a polymerization process, which may be any of addition polymerization, ring-opening polymerization, polyaddition, addition condensation or condensation polymerization, is dissolved in a solvent, the resulting resin solution is subjected to precipitation by adding a poor solvent or cooling after heating and dissolving, the solvent is sequentially removed to thereby obtain resin fine particles, and then the resulting resin fine particles are dispersed in an aqueous medium in the presence of a suitably selected dispersing agent, thereby producing the aqueous dispersion of the resin fine particles; (7) a preparation process of aqueous dispersion of the resin fine particles, in which a resin, previously prepared by a polymerization process, which may be any of addition polymerization, ring-opening polymerization, polyaddition, addition condensation or condensation polymerization, is dissolved in a solvent to thereby obtain a resin solution, the resin solution is dispersed in an aqueous medium in the presence of a suitably selected dispersing agent, and then the solvent is removed by heating or reduced pressure to thereby obtain the aqueous dispersion of the resin fine particles; (8) a preparation process of aqueous dispersion of the resin fine particles, in which a resin, previously prepared by a polymerization process, which is any of addition polymerization, ring-opening polymerization, polyaddition, addition condensation or condensation polymerization, is dissolved in a solvent to thereby obtain a resin solution, a suitably selected emulsifier is dissolved in the resin solution, and then water is added to the resin solution so as to induce phase inversion emulsification, thereby producing the aqueous dispersion of the resin fine particles.

Examples of toner include ones produced by conventional processes such as suspension-polymerization process, emulsion-aggregation process, emulsion-dispersion process, and the like. The toner is preferably produced through dissolving an active hydrogen group-containing compound and a polymer reactive with the compound in an organic solvent to prepare a toner solution, dispersing the toner solution in an aqueous medium so as to form a dispersion, allowing the active hydrogen group-containing compound and the polymer reactive with the compound to react so as to form an adhesive base material in the form of particles, and removing the organic solvent.

Toner Solution

The toner solution may be prepared by dissolving the toner materials in an organic solvent.

Organic Solvent

The organic solvent may be selected accordingly, provided that the organic solvent allows the toner material to be dissolved and/or dispersed therein. It is preferable that the organic solvent is a volatile organic solvent having a boiling point of less than 150° C. in terms of easy removal from the solution or dispersion. Suitable examples thereof are toluene, xylene, benzene, carbon tetrachloride, methylene chloride, 1,2-dichloroethane, 1,1,2-trichloroethane, trichloroethylene, chloroform, monochlorobenzene, dichloroethylidene, methylacetate, ethylacetate, methyl ethyl ketone, methyl isobutyl ketone, and the like. Among these solvents, toluene, xylene, benzene, methylene chloride, 1,2-dichloroethane, chloroform, carbon tetrachloride are preferable; and ethyl acetate is more preferable. These solvents may be used alone or in combination.

The amount of organic solvent may be selected accordingly; preferably, the amount is 40 parts by mass to 300 parts by mass, more preferably 60 parts by mass to 140 parts by mass, and most preferably 80 parts by mass to 120 parts by mass based on 100 parts by mass of the toner material.

Dispersion

The dispersion may be prepared through dispersing toner solution in an aqueous medium. When the toner solution is dispersed in an aqueous medium, a dispersing substance (oil droplets) is formed in the aqueous medium.

Aqueous Medium

The aqueous medium may be properly selected from conventional ones, and is exemplified by water, water-miscible solvents, and combinations thereof. Among these, water is particularly preferable.

The water-miscible solvent may be anything, as long as being miscible with water; examples thereof include alcohols, dimethylformamide, tetrahydrofuran, cellosolves, lower ketones, and the like.

Examples of alcohols include methanol, isopropanol, ethylene glycol, and the like. Examples of lower ketones include acetone, methyl ethyl ketone, and the like. These may be used alone or in combination.

The toner solution is preferably dispersed in the aqueous medium while stirring. The dispersing process may be selected on the basis of conventional dispersers such as low-speed-shear dispersers, high-speed-shear dispersers, friction dispersers, high-pressure-jet dispersers, supersonic dispersers, and the like. Among these, high-speed-shear dispersers are preferable because of controlling particle diameter of the dispersing substance (oil droplets) in the aqueous medium within a range of 2 μm to 20 μm.

When the high-speed shear disperser is used, conditions like rotating frequency, dispersion time, dispersion temperature, and the like may be properly selected. Preferably, the rotating frequency is 1000 rpm to 30,000 rpm, more preferably 5000 rpm to 20,000 rpm; the dispersion time is preferably 0.1 to 5 minutes in batch processes; the dispersion temperature is preferably 0° C. to 150° C., more preferably 40° C. to 98° C. Generally speaking, the dispersion is more easily carried out at higher temperatures.

An exemplary process for producing the toner will be explained in the following, in which an adhesive base material is produced in a form of particles.

In the process where the adhesive base material is produced in a form of particles, the toner is produced, for example, through preparation of an aqueous medium phase, preparation of toner solution, preparation of a dispersion liquid, addition of aqueous medium, and other processes such as synthesis of active hydrogen group-containing compound and reactive prepolymer thereof or synthesis of active hydrogen group-containing compound, and the like.

The aqueous medium phase may be, for example, prepared trough dispersing resin fine particles in the aqueous medium. The amount of resin fine particles added to the aqueous medium may be adjusted accordingly; preferably, the amount is 0.5% by mass to 10% by mass.

The toner solution may be prepared through dissolving and/or dispersing toner materials such as an active hydrogen group-containing compound, reactive prepolymer thereof, colorant, release agent, charge control agent and unmodified polyester resin, and the like into the organic solvent.

These toner materials other than the active hydrogen group-containing compound and the prepolymer reactive with the compound may be added and blended in the aqueous medium when resin fine particles are dispersed in the aqueous medium phase preparation, or they may be added into the aqueous medium phase together with toner solution when the toner solution being added into the aqueous medium phase.

The dispersion may be prepared through emulsifying and/or dispersing the previously prepared toner solution in the previously prepared aqueous medium phase. At the time of emulsifying and/or dispersing, the active hydrogen group-containing compound and the polymer reactive with the compound are subjected to elongation and/or crosslinking reaction, thereby forming the adhesive base material.

The adhesive base material (e.g. the urea-modified polyester) is formed, for example, by (1) emulsifying and/or dispersing the toner solution containing the polymer reactive with the compound (e.g. isocyanate group-containing polyester prepolymer (A)) in the aqueous medium phase together with the active hydrogen group-containing compound (e.g. amines (B)) so as to form a dispersion, and then the active hydrogen group-containing compound and the polymer reactive with the compound are subjected to elongation and/or crosslinking reaction in the aqueous medium phase; (2) emulsifying and/or dispersing toner solution in the aqueous medium previously added with the active hydrogen group-containing compound to form a dispersion, and then the active hydrogen group-containing compound and the polymer reactive with the compound are subjected to elongation and/or crosslinking reaction in the aqueous medium phase; (3) after adding and mixing toner solution in the aqueous medium, the active hydrogen group-containing compound is sequentially added thereto so as to form a dispersion, and then the active hydrogen group-containing compound and the polymer reactive with the compound are subjected to elongation and/or crosslinking reaction at an interface of dispersed particles in the aqueous medium phase. In the process (3), the modified polyester resin is also preferentially formed on the surface of manufacturing toner particles, thus it is possible to generate concentration gradient in the toner particles.

The reaction conditions for forming the adhesive base material through emulsifying and/or dispersing may be adjusted accordingly with a combination of active hydrogen group-containing compound and the polymer reactive with the compound. The reaction time is preferably from 10 minutes to 40 hours and more preferably from 2 hours to 24 hours. The reaction temperature is preferably from 0° C. to 150° C. and more preferably from 40° C. to 98° C.

The suitable formation of the dispersion containing the active hydrogen group-containing compound and the polymer reactive with the compound (e.g. the isocyanate group-containing polyester prepolymer (A)) in the aqueous medium phase is, for example, the process in which the toner solution, produced from toner materials such as the polymer reactive with the active hydrogen group-containing compound (e.g. the isocyanate group-containing polyester prepolymer (A)), colorant, wax, charge control agent, unmodified polyester, and the like that are dissolved and/or dispersed in the organic solvent, is added in the aqueous medium phase and dispersed by action of shear force. The detail of the dispersion process is as described above.

When preparing a dispersion, a dispersant is preferably used in order to stabilize the dispersing materials (oil droplets formed from toner solution) and sharpen the particle size distribution while yielding a desirable shape.

The dispersant may be selected accordingly; examples thereof include surfactants, water-insoluble inorganic dispersants, polymeric protective colloids, and the like. These may be used alone or in combination. Among these, surfactants are most preferable.

Examples of surfactants include anionic surfactants, cationic surfactants, nonionic surfactants, ampholytic surfactants, and the like.

Examples of anionic surfactants include alkylbenzene sulfonic acid salts, α-olefin sulfonic acid salts, phosphoric acid esters, and the like. Among these, anionic surfactants having fluoroalkyl group are preferable. Examples of the anionic surfactants having fluoroalkyl group include fluoroalkyl carboxylic acids of carbon number 2 to 10 or metal salts thereof, disodium perfluorooctanesulfonylglutamate, sodium-3-{omega-fluoroalkyl (carbon number 6 to 11)oxy}-1-alkyl (carbon number 3 to 4) sulfonate, sodium-3-{omega-fluoroalkanoyl (carbon number 6 to 8)-N-ethylamino-1-propanesulfonate, fluoroalkyl (carbon number 11 to 20) carboxylic acids or metal salts thereof, perfluoroalkyl (carbon number 7 to 13) carboxylic acids or metal salts thereof, perfluoroalkyl (carbon number 4 to 12) sulfonic acid or metal salt thereof, perfluorooctanesulfonic acid diethanol amide, N-propyl-N-(2-hydroxyethyl)perfluorooctanesulfone amide, perfluoroalkyl (carbon number 6 to 10) sulfoneamidepropyltrimethylammonium salt, perfluoroalkyl (carbon number 6 to 10)-N-ethylsulfonyl glycin salt, monoperfluoroalkyl(carbon number 6 to 16)ethylphosphate ester, and the like. Examples of commercially available surfactants containing fluoroalkyl group are Surflon S-111, S-112 and S-113 (by Asahi Glass Co.); Frorard FC-93, FC-95, FC-98 and FC-129 (by Sumitomo 3M Ltd.); Unidyne DS-101 and DS-102 (by Daikin Industries, Ltd.); Megafac F-110, F-120, F-113, F-191, F-812 and F-833 (by Dainippon Ink and Chemicals, Inc.); ECTOP EF-102, 103, 104, 105, 112, 123A, 123B, 306A, 501, 201 and 204 (by Tohchem Products Co.); Futargent F-100 and F150 (by Neos Co.).

Examples of cationic surfactants include amine salt surfactants, quaternary ammonium salt surfactants, and the like. Examples of amine salt surfactants include alkyl amine salts, aminoalcohol fatty acid derivatives, polyamine fatty acid derivatives, imidazoline, and the like. Examples of quaternary ammonium salt surfactants include alkyltrimethyl ammonium salts, dialkyldimethyl ammonium salts, alkyldimethyl benzyl ammonium salts, pyridinium salts, alkyl isoquinolinium salts, benzethonium chloride, and the like. Among these, preferable examples are primary, secondary or tertiary aliphatic amine acids having fluoroalkyl group, aliphatic quaternary ammonium salts such as perfluoroalkyl (carbon number 6 to 10) sulfoneamidepropyl trimethylammonium salt, benzalkonium salts, benzetonium chloride, pyridinium salts, imidazolinium salts, and the like. Specific examples of commercially available product thereof are Surflon S-121 (by Asahi Glass Co.) Frorard FC-135 (by Sumitomo 3M Ltd.), Unidyne DS-202 (by Daikin Industries, Ltd.), Megafack F-150 and F-824 (by Dainippon Ink and Chemicals, Inc.), Ectop EF-132 (by Tohchem Products Co.), and Futargent F-300 (by Neos Co.).

Examples of nonionic surfactants include fatty acid amide derivatives, polyhydric alcohol derivatives, and the like. Examples of ampholytic surfactants include alanine, dodecyldi(aminoethyl)glycin, di(octylaminoethyl)glycin, N-alkyl-N,N-dimethylammonium betaine, and the like.

Examples of water-insoluble inorganic dispersant include tricalcium phosphate, calcium carbonate, titanium oxide, colloidal silica, hydroxyl apatite, and the like.

Examples of polymeric protective colloid are acids, (meth)acrylic monomers having hydroxyl group, vinyl alcohols or esters thereof, esters of vinyl alcohol and compound having carboxyl group, amide compounds or methylol compounds thereof, chlorides, monopolymers or copolymers having nitrogen atom or heterocyclic rings thereof, polyoxyethylenes, celluloses, and the like.

Examples of acids include acrylic acid, methacrylic acid, α-cyanoacrylic acid, α-cyanomethacrylic acid, itaconic acid, crotonic acid, fumaric acid, maleic acid, maleic anhydride, and the like. Examples of (meth)acrylic monomers having hydroxyl group include β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycol monoacrylic ester, diethyleneglycol monomethacrylic ester, glycerin monoacrylic ester, glycerin monomethacrylic ester, N-methylol acrylamido, N-methylol methacrylamide, and the like. Examples of vinyl alcohols or ethers of vinyl alcohol include vinyl methyl ether, vinyl ethyl ether, vinyl propyl ether, and the like. Examples of ethers of vinyl alcohol and compound having carboxyl group include vinyl acetate, vinyl propionate, vinyl butyrate, and the like. Examples of amide compound or methylol compound thereof include acryl amide, methacrylic amide, diacetone acrylic amide acid, or methylol thereof, and the like. Examples of chlorides include acrylic chloride, methacrylic chloride, and the like. Examples of monopolymers or copolymers having nitrogen atom or heterocyclic rings thereof include vinyl pyridine, vinyl pyrrolidone, vinyl imidazole, ethylene imine, and the like. Examples of polyoxyethylenes include polyoxyethylene, polyoxypropylene, polyoxyethylene alkylamine, polyoxypropylene alkylamine, polyoxyethylene alkylamide, polyoxypropylene alkylamide, polyoxyethylene nonylphenylether, polyoxyethylene laurylphenylether, polyoxyethylene stearylphenyl ester, polyoxyethylene nonylphenyl ester, and the like. Examples of celluloses include methyl cellulose, hydroxyethyl cellulose, hydroxypropyl cellulose, and the like.

In the preparation of a dispersion, a dispersing stabilizer may be employed as required. The dispersing stabilizer is, for example, an acid-soluble or alkali-soluble compound such as calcium phosphate, and the like.

When a dispersing stabilizer is employed, the dispersing stabilizer is dissolved by action of an acid such as hydrochloric acid, and then washed with water or decomposed by enzyme, etc. to be removed from particles.

In the preparation of the dispersion, a catalyst for the elongation and/or crosslinking reaction may be employed as necessary. The catalyst is, for example, dibutyltin laurate, dioctyltin laurate, and the like.

The organic solvent is removed from the resulting dispersion (emulsified slurry). The removal of organic solvent is carried out, for example, by the following methods: (1) the temperature of the dispersion is gradually raised, and the organic solvent in the oil droplets are completely evaporated and removed; (2) emulsified dispersion is sprayed in a dry atmosphere and the water-insoluble organic solvent is completely evaporated and removed from the oil droplets to form toner particles, while aqueous dispersant being evaporated and removed simultaneously.

Once organic solvent is removed, toner particles are formed. The toner particles are then processes with washing, drying, and the like, then toner particles may be classified as necessary. The classification is, for example, carried out using a cyclone, decanter, or centrifugal separation thereby removing particles in the solution. Alternatively, the classification may be carried out after toner particles are produced in a form of powder through drying.

The resulting toner particles are mixed with a colorant, wax, charge control agent, etc., or subjected to mechanical impact, thereby preventing falling off of particles such as of release agents.

Examples of the process for imparting mechanical impact are exemplified by impacting a force by action of blades rotating at high speed, or making collide particles each other or against a collision plate. Examples of device employed for such processes are Angmill (by Hosokawamicron Corp.), I-type mill (by Nippon Pneumatic Mfg. Co., Ltd.), hybridization system (by Nara Machinery Co., Ltd.), krypton system (by Kawasaki Heavy Industries, Ltd.), automatic mortar, and the like.

It is preferred that the toner has, as described below, a mass-average particle diameter (D₄), ratio (D₄/Dn) of mass-average particle diameter to number-average particle diameter (Dn), average circularity, shape factors SF-1 and SF-2.

The mass-average particle diameter (D₄) of the toner is preferably 2 μm to 7 μm, more preferably 4 μm to 7 μm, and most preferably 5 μm to 6 μm.

The process for determining the mass-average particle diameter (D₄) is as follows:

Apparatus: Coulter Multitizer II (by Beckman Coulter Co.)

Aperture diameter: 100 μm

Software: Coulter Multitizer Acucomp ver. 1.19 (by Beckman Coulter Co.)

Electrolyte: Isoton II (by Beckman Coulter Co.)

Dispersant: Emulgen 109P 5% electrolyte (by Kao Co., polyoxyethylene laurylether, HLB: 13.6)

Dispersing condition: a sample 10 mg is added to a dispersion liquid 5 mL, and dispersed for one minute using an ultrasonic dispersing device, to which an electrolyte 25 mL is added and the mixture is further dispersed for one minute using the ultrasonic dispersing device.

Measuring condition: an electrolyte 100 mL and a dispersant are poured into a beaker, 30 thousand particles are measured at a concentration capable of measuring the particle diameter of 30 thousand particles for a period of 20 seconds, then a mass-average particle diameter is determined from the data.

In cases where the mass-average particle diameter is below 2 μm, the toner may deposit adhesively on carrier surface under a prolonged stirring period in developing units when two-component developer being employed, and the toner tends to deposit adhesively on some members such as blades due to toner filming on developing rollers or thin layers of the toner when one-component developer being employed. In cases where the mass-average particle diameter is above 7 μm, images may be hardly obtainable with high resolution and high quality, and toner particle sizes may alter considerably during supply and consumption of the toner in developers.

The ratio (D₄/Dn) of the mass-average particle diameter (D₄) to the number-average particle diameter (Dn) of the toner is preferably 1.25 or less, more preferably 1.00 to 1.20, and most preferably 1.10 to 1.20.

When the ratio is 1.25 or less, the toner has a relatively sharp particle size distribution and thus may have improved fixing ability. When the ratio is less than 1.00, the toner of two-component developer is likely to fuse onto the carrier surfaces while stirring in a developing unit for a long period, thereby degrading charging capability of the carrier or cleaning properties, and one-component developer is likely to cause filming onto the developing roller or fusion onto the member such as blades for reducing toner layer thickness. When the ratio is more than 1.20, high-resolution and high-quality images are hardly obtainable, and the toner particle diameter may considerably fluctuate when toner inflow/outflow is implemented in developers.

The mass-average particle diameter and the ratio (D₄/Dn) may be measured, for example, by means of the particle size analyzer MultiSizer II (by Beckmann Coulter Inc.) described above.

Average circularity means a value of circle circumference, having the same project area of toner particles to be measured, divided by the actual circumference of toner particles to be measured. The average circularity is preferably 0.900 to 0.98 and more preferably 0.940 to 0.98.

The average circularities of less than 0.900 correspond to irregular toner shape far from circle, thus it is difficult to take high quality images with satisfactory transfer ability and without dusts; meanwhile, the average circularities of above 0.99 tend to cause inferior cleaning on photoconductors or transfer belts in image forming systems equipped with cleaning blades and to contaminate images, for example, toners of untransferable images due to paper-feed failure in cases of image area rates may remain on photoconductors to pollute background or to contaminate charge rollers thus inhibiting the charging capacity.

The average circularity may be measured, for example, by the optical detection zone method in which a toner-containing suspension is passed through an image-detection zone disposed on a plate, the particle images of the toner are optically detected by CCD camera, and the resulting particle images are analyzed. An available analyzing apparatus is a flow-type particle image analyzer FPIA-2100 (by Sysmex Corp.).

It is preferred that the shape factor SF-1, which being expressed by the Equation (1) below to represent a spherical level, is 100 to 150 and the shape factor SF-2, which being expressed by the Equation (2) to represent an irregularity level, is 100 to 140.

The shape factors SF-1 and SF-2 may be determined, for example and not limited to, by way of taking SEM images of a toner by FE-SEM (S-4200, by Hitachi Ltd.), sampling randomly 300 images, inputting the image data into an image analysis apparatus (Luzex AP, by Nireco Co.) through an interface, and calculating from the Equations (1) and (2) below.

$$SF - 1 = \frac{{( MXLNG )}^{2}}{AREA} \times \frac{π}{4} \times 100 \text{:} \qquad Equation ( 1 )$$

The “MXLNG” in the Equation (1) represents the maximum length of the projected shape of the toner particle on two-dimensional plane. The “AREA” represents the area of the projected shape of the toner particle on two-dimensional plane.

$$SF - 2 = \frac{{( PERI )}^{2}}{AREA} \times \frac{1}{4 π} \times 100 \text{:} \qquad Equation ( 2 )$$

The “PERI” in the Equation (2) represents the peripheral length of the projected shape of the toner particle on two-dimensional plane. The “AREA” represents the area of the projected shape of the toner particle on two-dimensional plane.

In a case that the toner particle is spherical, both of SF-1 and SF-2 are 100; the higher is the value apart from 100, the shape becomes more indefinite. SF-1 typically represents overall shape such as ellipse or sphere, and SF-2 represents irregularity or roughness of toner surface.

The color of the toner may be properly selected depending on the application; for example, the coloration may be one selected from black, cyan, magenta and yellow. The coloration may be carried out through appropriately selecting toners.

Developer

The developer in the present invention contains at least the toner of the present invention and further contains other optional ingredients such as carriers described above. The developer may be of one-component or two-component. Here, two-component developers are preferable so as to match with state-of-the-art high speed printers in view of long lifetime.

The one-component developers, using the toner of the present invention, may exhibit less fluctuation in toner-particle diameter even after toner inflow/outflow, and also bring about less toner filming on developing rollers or toner fusion onto members such as blades, therefore providing excellent and stable developing property and images over long-term in developing units. The two-component developers, using toner of the present invention, may exhibit less fluctuation in the toner particle diameter after toner inflow/outflow for prolonged periods, and the excellent and stable developing property may be maintained after stirring in developing units for prolonged periods.

The carrier may be properly selected depending on the application; preferably, the carrier has a core material and a resin layer on the core material.

The core material may be properly selected from conventional ones; examples thereof include manganese-strontium (Mn, Sr) materials and manganese-magnesium (Mn, Mg) materials of 50 emu/g to 90 emu/g, and also highly magnetized materials such as iron powder (100 emu/g or more) and magnetite (75 emu/g to 120 emu/g) in view of ensuring appropriate image density. Weak-magnetizable materials such as copper-zinc (Cu—Zn) materials (30 emu/g to 80 emu/g) are also preferred in view of reducing impact on photoconductors where magnetic brushes being formed and high image quality. These may be used alone or in combination.

The mass-average particle diameter D₅₀ of the core material is preferably 10 μm to 200 μm and more preferably 40 μm to 100 μm.

When the mass-average particle diameter D₅₀ is less than 10 μm, the amount of fine powder in the carrier particle size distribution increases whereas magnetization per particle decreases, resulting possibly in the carrier scattering. When the average particle diameter is more than 200 μm, the specific surface area decreases and the toner tends to scatter, and full-color images with much solid parts tend to impair reproducibility at the solid parts in particular.

The resin material may be properly selected from conventional ones; examples thereof include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, copolymers of vinylidene fluoride and acryl monomer, copolymers of vinylidene fluoride and vinyl fluoride, fluoroterpolymers such as terpolymer of tetrafluoroethylene, vinylidene fluoride and non-fluoride monomer, and silicone resins. These may be used alone or in combination.

Examples of amino resins include urea-formaldehyde resins, melamine resins, benzoguanamine resins, urea resins, polyamide resins, epoxy resins, and the like. Examples of polyvinyl resins include acryl resins, polymethylmethacrylate resins, polyacrylonitrile resins, polyvinyl acetate resins, polyvinyl alcohol resins, polyvinyl butyral resins, and the like. Examples of polystyrene resins include polystyrene resins, styrene acryl copolymer resins, and the like. Examples of halogenated olefin resins include polyvinyl chlorides, and the like. Examples of polyester resins include polyethyleneterephthalate resins and polybutyleneterephthalate resins, and the like.

The resin layer may contain, for example, conductive powder, etc. as necessary. Examples of conductive powder include metal powder, carbon black, titanium oxide, tin oxide, zinc oxide, and the like. The average particle diameter of conductive powder is preferably 1 μm or less. When the average particle diameter is more than 1 μm, controlling the electrical resistance may be difficult.

The resin layer may be formed, for example, by dissolving the silicone resins, etc. in a solvent to prepare a coating solution, uniformly applying the coating solution to the surface of core material by conventional processes, then drying and baking. Examples of coating processes include immersion, spray, and brushing, etc.

The solvent may be properly selected depending on the application; examples thereof include toluene, xylene, methylethylketone, methylisobutylketone, cellosolve, butylacetate, and the like.

The baking may be carried out through external or internal heating. Examples of the baking processes include those by use of electric furnaces, flowing electric furnaces, rotary electric furnaces, burner furnaces, microwave, or the like.

The content of resin layer in the carrier is preferably 0.01% by mass to 5.0% by mass. When the content is less than 0.01% by mass, the resin layer may be formed nonuniformly on the surface of the core material, and when the content is more than 5.0% by mass, the resin layer may become excessively thick to cause granulation between carriers, and carrier particles may be formed nonuniformly.

When the developer is a two-component developer, the content of the carrier in the two-component developer may be selected accordingly; preferably, the content is 90% by mass to 98% by mass, more preferably 93% by mass to 97% by mass.

The mixing ratio of toner to carrier in the two-component developer is 1 part by mass to 10.0 parts by mass of toner based on 100 parts by mass of carrier.

The developer in the present invention may maintain proper transfer ability and cleaning property for long period, exhibit less image fluctuation, and represent less embedding of external additives even under stirring the developer at use, and also the developer contains the inventive toner with stable flowability and charging ability for long period, thus leading to stable formation of excellent clear image with higher quality.

The developer in the present invention may be suitably used in forming images by various conventional electrophotographic processes such as magnetic one-component developing, non-magnetic one-component developing, two-component developing, and the like. In particular, the developer of the present invention may be suitably used in the toner-containing containers, process cartridges, image forming apparatuses, and image forming methods according to the present invention as described below.

Toner-Containing Container

The toner-containing container of the present invention is one filled with the toner and/or the developer of the present invention. The container may be selected from conventional ones; preferable examples thereof include those having a toner-container body and a cap.

The toner-container body may be properly selected for the size, shape, structure or material. It is preferred that the shape is cylindrical, more specifically, a spiral ridge is formed on the inner surface and the contained toner is movable toward discharging end when being rotated, and the spiral portion partly or entirely serves as bellows.

It is preferred that the material of the toner-container body is dimensionally accurate; for example, resins are preferable. Preferable examples of the resins include polyester resins, polyethylene resins, polypropylene resins, polystyrene resins, polyvinyl chloride resins, polyacrylic acids, polycarbonate resins, ABS resins, and polyacetal resins.

The toner-containing container of the present invention is convenient to preserve, transport and handle, and may be suitably used through detachably mounting to process cartridges, image forming apparatuses for supplying toners.

Process Cartridge

The process cartridge of the present invention comprises a photoconductor for bearing a latent electrostatic image and a developing unit for developing the latent electrostatic image on the photoconductor using developer, and further comprises a charging unit, exposing unit, developing unit, transferring unit, cleaning unit, discharging unit and other units selected accordingly.

The developing unit contains at least a developer container for storing the toner and/or developer of the present invention and a developer carrier for carrying and transferring the toner and/or developer stored in the developer container and may further contain a layer-thickness control member for controlling the thickness of carried toner layer.

The process cartridge of the present invention may be detachably mounted on a variety of electrophotographic apparatuses, facsimiles and printers, and is preferably detachably mounted on the electrophotographic apparatuses of the present invention.

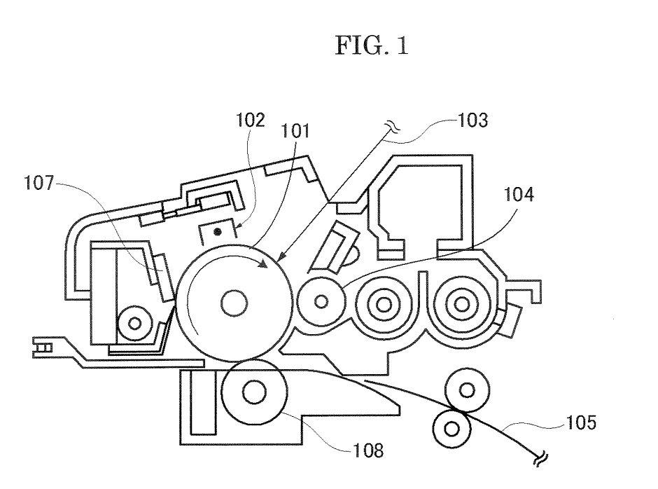

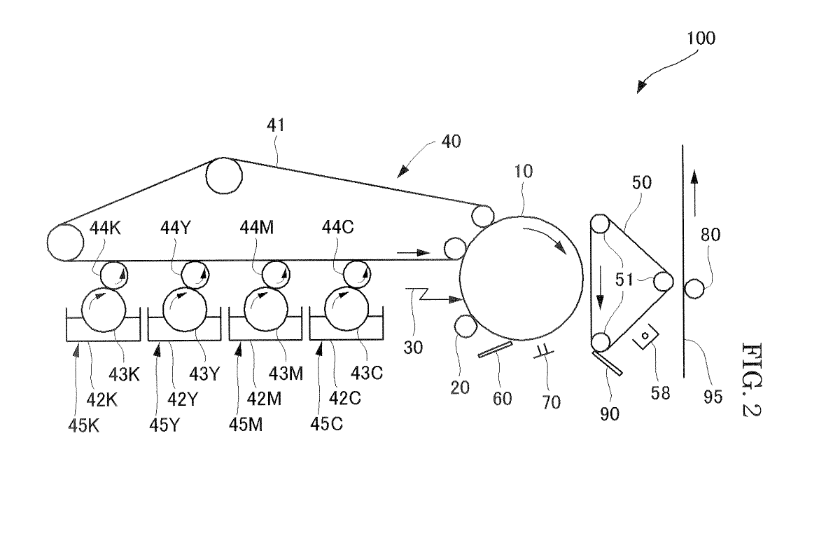

The process cartridge comprises, for example as shown in FIG. 1, built-in photoconductor 101, charging unit 102, developing unit 104, cleaning unit 107, and transferring unit 108 and also other members as required. FIG. 1 also shows an exposure unit 103 that is equipped with a light source capable of high resolution writing, and also a recording medium 105 is shown.

The photoconductor 101 may be similar with that of the image forming apparatus described later. The charging unit 102 may be conventional ones.

In the image forming process by use of the process cartridge shown in FIG. 1, a latent electrostatic image, corresponding to the exposed image, is formed on the surface of the photoconductor 101, rotating in the arrow direction, by the charging unit 102 and the exposure 103 of an exposing unit (not shown). The latent electrostatic image is toner-developed by means of the developing unit 104, the toner image is then transferred to the recording medium 105 by means of the transferring unit 108 and printed out. Then the photoconductor surface after the image transfer is cleaned by means of the cleaning unit 107, followed by discharging through a charge-eliminating unit (not shown) and these operations are carried out repeatedly.

The image forming apparatus of the invention may be constructed into a process cartridge containing a photoconductor, developing unit and cleaning unit, placed onto the main body detachably. Alternatively, a process cartridge containing a photoconductor and at least one selected from a charger, image exposing device, developing unit, transfer or separation unit and cleaning unit may be constructed and placed onto the main body of the image forming apparatus as a detachable single-unit, and may be designed with a guidance unit such as main body rails, etc.

Image Forming Apparatus and Image Forming Method

The image forming apparatus of the present invention contains a photoconductor, latent electrostatic image forming unit, developing unit, transferring unit, fixing unit and other units such as a discharging unit, recycling unit and control unit as necessary.

The image forming method of the present invention includes a step of forming a latent electrostatic image, a developing step, a transferring step, a fixing step and other steps such as discharging, cleaning, recycling, controlling, as necessary.

The image forming method of the present invention may be favorably implemented by use of the image forming apparatus of the present invention. The step of forming a latent electrostatic image may be performed by the latent electrostatic image forming unit, the developing may be performed by the developing unit, the transferring may be performed by the transferring unit, and the fixing may be performed by the fixing unit; and other steps may be performed by other units respectively.

Step of Forming Latent Electrostatic Image and Latent Electrostatic Image Forming Unit

The step of forming a latent electrostatic image is one that forms a latent electrostatic image on the photoconductor. Materials, shapes, structures or sizes, etc. of the photoconductor may be selected accordingly, and the photoconductor is preferably of a drum shape. The materials for inorganic photoconductors are amorphous silicon, selenium, for organic photoconductors are polysilane, phthalopolymethine, for example. Among these materials, amorphous silicon is preferred by virtue of longer operating life.

The amorphous silicon photoconductor may be one having a photoconductive layer of a-Si (hereafter sometimes referred to as “a-Si photoconductor”), in which a photoconductive layer of a-Si is formed on a support, which being heated at 50° C. to 400° C., by a coating process such as vacuum deposition, sputtering, ion-plating, thermo-CVD, photo-CVD and plasma-CVD. Among others, plasma-CVD is preferable, in which a-Si deposition layer is formed on the support by decomposition of raw gas using direct current, high-frequency wave, or microwave glow discharge.

The latent electrostatic image may be formed, for example, by uniformly charging the surface of photoconductors, and irradiating imagewisely, which may be performed in the latent electrostatic image forming unit. The latent electrostatic image forming unit, for example, contains a charger which uniformly charges the surface of photoconductor, and an irradiator which exposes the surface of latent image bearing member imagewise.

The charging may be performed, for example, by applying a voltage to the surface of photoconductor using a charger. The charger may be selected accordingly; examples thereof include conventional contact chargers equipped with conductive or semi-conductive roller, brush, film or rubber blade and non-contact chargers using corona discharges such as corotron and scorotron.

The configuration of charging members may be of magnetic brush, fur brush or any other configurations other than of the roller, and may be selected depending on the configuration of the electrophotographic apparatus. In the apparatus where a magnetic brush is used, the magnetic brush is constructed with various ferrite particles such as Zn—Cu ferrite used as charging members, nonmagnetic conductive sleeve supporting the charging member, and the magnet roll contained in the nonmagnetic conductive sleeve. When a brush is used, for example, a fur is made conductive by carbon, copper sulfide, metal or metal oxide, and is winded around or stuck to cored bars which being made conductive by metals or others.

The charger is preferably, but not limited to, a contact charger because of the ability to decrease ozone gas generated from charger in the image-forming apparatus.

Exposures may be performed by exposing the surface of photoconductor imagewise using exposure machines, for example.

The exposure device may be anything as long as capable of exposing the surface of photoconductor to form an image may be selected accordingly. Examples thereof include various exposure devices such as copy optical systems, rod lens array systems, laser optical systems, and liquid crystal shutter optical systems. A backlight system may be employed in the invention where the photoconductor is exposed imagewisely from the rear surface.

Developing Step and Developing Unit

The developing step is one where a latent electrostatic image is developed using toner and/or developer of the invention to form a visible image. The visible image may be formed, for example, by developing a latent electrostatic image using toner and/or developer, which may be performed by the developing unit.

The developing unit may be anything as long as capable of developing an image by using toner and/or developer, and may be selected from conventional developing units accordingly. Examples thereof include those reserving developers or toners for supplying to the latent electrostatic images with or without contact.

The developing unit may be of dry or wet developing systems and may also be for single or multiple colors; preferable examples thereof include ones having a mixer to charge toner and/or developer by friction-stirring and a rotatable magnet roller.

In the developer, the toner and the carrier may, for example, be mixed and stirred together. The toner is charged by friction, and forms a magnetic brush on the surface of the rotating magnet roller. Since the magnet roller is arranged near the photoconductor, a part of lo the toner constructing the magnetic brush formed on the surface of the magnet roller is moved toward the surface of the photoconductor due to the force of electrical attraction. As a result, a latent electrostatic image is developed by the use of toner, and a visible toner image is formed on the surface of the photoconductor.

The developer contained in the developing unit is one containing a toner, and may be of one-component or two-component. The toner contained in the developer is the toner of the present invention.

Transferring Step and Transferring Unit

The transferring step is one transferring the visible image to a recording medium. In a preferable aspect, a first transferring is performed, using an intermediate transferring member to transfer the visible image to the intermediate transferring member, and a second transfer is performed to transfer the visible image to the recording medium. In a more preferable aspect, toners of two or more colors, preferably full-color, are employed, the first transferring performs to transfer the visible image to the intermediate transferring member thereby to form a compounded transfer image, and the second transferring performs to transfer the compounded transfer image to the recording medium.

The visible-image transfer may be carried out, for example, by charging the photoconductor using a transferring charger, which may be performed by the transferring unit. In a preferable aspect, the transferring unit contains the first transferring unit which transfers the visible image to the intermediate transferring member to form a compounded transfer image, and the second transferring unit which transfers the compounded transfer image to the recording medium.

The intermediate transferring member may be properly selected from conventional transferring members, for example, transfer belts are preferable.

The stationary friction coefficient of the intermediate transferring member is preferably 0.1 to 0.6 and more preferably 0.3 to 0.5. The volume resistance of intermediate transferring member is preferably more than several Ω·cm and less than 10³ Ω·cm. The volume resistance within the range of several Ω·cm to 10³ Ω·cm may prevent charging of the intermediate transferring member itself, and the charge from the charging unit is unlikely to remain on the intermediate transferring member, therefore, transfer nonuniformity at the secondary transferring may be prevented and the application of transfer bias at the secondary transferring becomes relatively easy.

The materials of the intermediate transferring member may be properly selected from conventional ones accordingly. The materials are, for example, (1) materials with high Young's modulus (tension elasticity) used as a single layer belt such as polycarbonates (PC), polyvinylidene fluoride (PVDF), polyalkylene terephthalate (PAT), blend materials of PC/PAT, ethylene tetrafluoroethylene copolymer (ETFE)/PC, and ETFE/PAT, thermosetting polyimides of carbon black dispersion, and the like. These single layer belts having high Young's modulus are small in their deformation against stress during image formation and are particularly advantageous in that registration error is less likely to occur during color image formation. (2) A double or triple layer belt using above-described belt having high Young's modulus as a base layer is available, where being added with a surface layer and an optional intermediate layer around the peripheral side of the base layer. The double or triple layer belt has a capability of preventing dropout in a lined image that is caused by hardness of the single layer belt. (3) A belt with relatively low Young's modulus is available that incorporates a rubber or an elastomer. This belt is advantageous in that there is almost no print defect of unclear center portion in a line image due to its softness. Additionally, by making width of the belt wider than drive roller or tension roller and thereby using the elasticity of edge portions that extend over rollers, it can prevent meandering of the belt. It is also cost effective for not requiring ribs or units to prevent meandering.

Conventionally, intermediate transfer belts have been made from fluorine resins, polycarbonate resins, polyimide resins, and the like; recently, elastic belts, in which elastic members being used in all or partial layers, are used as the intermediate transfer belts. There are some issues to transfer color images by use of resin belts as described below.

Color images are typically formed from four color toners. In one color image, 1 to 4 toner layers are formed. The toner layers are pressurized while passing through the primary transferring (in which toner is transferred to the intermediate transfer belt from the photoconductor) and the secondary transferring (in which toner is transferred to the sheet from the intermediate transfer belt), and the cohesive force increases between toner particles. As the cohesive force increases, problems are likely to occur, such as letter voids or edge dropout of solid images. Since resin belts are too hard to deform compliant to the toner layers and tend to compress the toner layers, therefore letter dropout is likely to occur.

Recently, demand is increasing toward printing full color images on various types of paper such as Japanese paper or the paper having a rough surface. However, the paper having a rough surface is likely to have a gap between toners and sheets at transferring and therefore leading to transfer errors. When the transfer pressure of secondary transfer section is increased in order to enhance adhesiveness, the cohesive force of the toner layers becomes high, resulting in the letter dropout as described above.

Elastic belts are used for the following purposes. Elastic belts deform corresponding to the surface roughness of toner layers and the sheet having low smoothness in the transfer section. In other words, since elastic belts deform complying with partial roughness and an appropriate adhesiveness may be obtained without excessively increasing the transfer pressure against toner layers, it is possible to obtain transfer images having excellent uniformity with no letter dropout even with the paper of lower flatness.

The resin of the elastic belts may be selected accordingly; examples of the resins include polycarbonate resins, fluorine resins such as ETFE and PVDF; polystyrene resins, chloropolystyrene resins, poly-α-methylstyrene resins, styrene-butadiene copolymers, styrene-vinyl chloride copolymer, styrene-vinyl acetate copolymer, styrene-maleic acid copolymer, styrene-acrylate copolymers such as styrene-methyl acrylate copolymers, styrene-ethyl acrylate copolymers, styrene-butyl acrylate copolymers, styrene-octyl acrylate copolymers, and styrene-phenyl acrylate copolymers; styrene-methacrylate copolymers such as styrene-methyl methacrylate copolymers, styrene-ethyl methacrylate copolymers and styrene-phenyl methacrylate copolymer; styrene-α-chloromethyl acrylate copolymers, styrene-acrylonitrile acrylate copolymers, methyl methacrylate resins, butyl methacrylate resins, ethyl acrylate resins, butyl acrylate resins, modified acrylic resins such as silicone-modified acrylic resins, vinyl chloride resin-modified acrylic resins and acrylic urethane resin; vinyl chloride resins, styrene-vinyl acetate copolymers, vinyl chloride-vinyl acetate copolymers, rosin-modified maleic acid resins, phenol resins, epoxy resins, polyester resins, polyester polyurethane resins, polyethylene resins, polypropylene resins, polybutadiene resins, polyvinylidene chloride resins, ionomer resins, polyurethane resins, silicone resins, ketone resins, ethylene-ethylacrylate copolymers, xylene resins, polyvinylbutylal resins, polyamide resins and modified polyphenylene oxide resins.

The rubbers and elastomers of the elastic materials may be selected accordingly; examples thereof include butyl rubber, fluorine rubber, acrylic rubber, ethylene propylene rubber (EPDM), acrylonitrilebutadiene rubber (NBR), acrylonitrile-butadiene-styrene natural rubber, isoprene rubber, styrene-butadiene rubber, butadiene rubber, ethylene-propylene rubber, ethylene-propylene terpolymer, chloroprene rubber, chlorosufonated polyethylene, chlorinated polyethylene, urethane rubber, syndiotactic 1,2-polybutadiene, epichlorohydrin rubber, silicone rubber, fluorine rubber, polysulfurized rubber, polynorbornen rubber, hydrogenated nitrile rubber, thermoplastic elastomers such as polystyrene elastomers, polyolefin elastomers, polyvinyl chloride elastomers, polyurethane elastomers, polyamide elastomers, polyurea elastomers, polyester elastomers and fluorine resin elastomers.

The conductive agents for adjusting resistance may be selected depending on the application; examples thereof include carbon black, graphite, metal powders such as aluminum and nickel; electric conductive metal oxides such as tin oxide, titanium oxide, antimony oxide, indium oxide, potassium titanate, antimony tin oxide (ATO) and indium tin oxide (ITO). The conductive metal oxides may be coated with insulating particles such as barium sulfate, magnesium silicate, calcium carbonate, and the like.

The materials of surface layer of transfer belts are required to prevent contamination of photoconductors by elastic material as well as to reduce the surface friction of transfer belts so that toner adhesion is lessened and also the cleaning ability and the secondary transfer property are improved. The materials are exemplified by polyurethanes, polyesters or epoxy resins and additional substances, for reducing surface energy and enhancing lubricity, such as fluorine resins, fluorine compounds, carbon fluorides, titanium dioxide and silicon carbide. In addition, fluorine rubber, heat-treated to form a fluorine-rich layer on the surface, may also be employed to reduce surface energy.

The transfer belts may be produced, for example but not limited to, by centrifugal forming processes in which materials are cast into rotating cylindrical molds to form a belt, spray coating processes in which a liquid paint is sprayed to form a film, dipping processes in which a cylindrical mold is dipped into a raw-material solution and pulled out, injection molding processes in which a raw material is injected between inner and outer molds, winding processes in which a compounded material is wound onto a cylindrical mold, and vulcanized and grounded.

In order to prevent undesirable elongation of the elastic belts, but not limited to, a rubber layer is formed onto a core resin layer with less elongation, or elongation-inhibiting material is incorporated into a core layer.

Examples of the materials for the elongation-inhibiting material include natural fibers such as cotton and silk; synthetic fibers such as polyester fibers, nylon fibers, acrylic fibers, polyolefin fibers, polyvinyl alcohol fibers, polyvinyl chloride fibers, polyvinylidene chloride fibers, polyurethane fibers, polyacetal fibers, polyfluoroethylene fibers and phenol fibers; inorganic fibers such as carbon fibers, glass fibers and boron fibers; metal fibers such as iron fibers and copper fibers. These materials are preferably made into a form of weave or thread.

The thread may be of twisted one or more filaments, and twisting processes may be twisting, multiple twisting, doubled yarn, or the like. Further, fibers of different materials selected from the above-mentioned group may be spun together. The thread may be treated to be electrically conductive before use. On the other hand, weave fabrics may be of anything including plain knitting or combined weave.

The process for producing the core layers may be properly selected; example thereof include a method in which a fabric, woven into a cylindrical shape, is placed on a mold and a coating layer is formed thereon, a method in which a cylindrical weave is dipped in a liquid rubber so that a coating layer is formed a side of core layers, and a method in which a thread is wound helically to a mold in an optional pitch, and then a coating layer is formed thereon.

When the elastic layer being too thick, elongation and contraction tend to be enlarged, which possibly causing cracks on the surface layer; and the higher elongation and contraction increase in turn elongation and contraction of images; therefore, excessive thickness such as about 1 mm or more is undesirable.

The transferring units of the first and the second transferring preferably contain an image transferring unit that releases the visible image formed on the photoconductor to the recording-medium by charging. There may be one, two or more of transferring units. The transferring unit may be a corona transferring unit based on corona discharge, transfer belt, transfer roller, pressure transfer roller, or adhesion transferring unit, for example.

The recording medium may be anything as long as capable of transferring unfixed images after development and may be selected accordingly. The recording medium is typically regular paper, and other materials such as polyethylene terephthalate (PET) sheets for overhead projector (OHP) may also be utilized.

The fixing step is one that fixes visible images transferred to the recording medium using a fixing unit. The fixing may be carried out for each color upon transferred onto the recording medium, or simultaneously after all colors are laminated.

The fixing unit may be properly selected from conventional heating and pressing units; examples thereof include combinations of heating rollers and pressing rollers, and combinations of heating rollers, pressing rollers, and endless belts. The heating temperature in the heating and pressing units is preferably 80° C. to 200° C. In addition, conventional optical fixing units may be used along with or in place of the fixing unit, depending on the application.

The charge-eliminating step is one that applies a discharge bias to the photoconductor, and may be performed by a charge-eliminating unit. The charge-eliminating unit may be anything as long as capable of applying discharge bias to the photoconductor such as discharge lamps, and may be selected from conventional charge-eliminating units accordingly.

The cleaning step is one in which residual toner on the photoconductor is removed, and typically performed by a cleaning unit.

Any conventional cleaning unit may be available as long as capable of removing residual toners on the photoconductor, and examples thereof include magnetic brush cleaners, electrostatic brush cleaners, magnetic roller cleaners, blade cleaners, brush cleaners, and web cleaners.

The recycling step is one in which the color toner, removed in the cleaning step, is recycled for use in the developing, and typically performed by a recycling unit. The recycling unit may be properly constructed from conventional transport devices.

The controlling step is one in which the respective processes are controlled and typically carried out by a controlling unit. Any conventional controlling units capable of controlling the performance of each unit may be selected accordingly. Examples thereof include instruments such as sequencers or computers, etc.

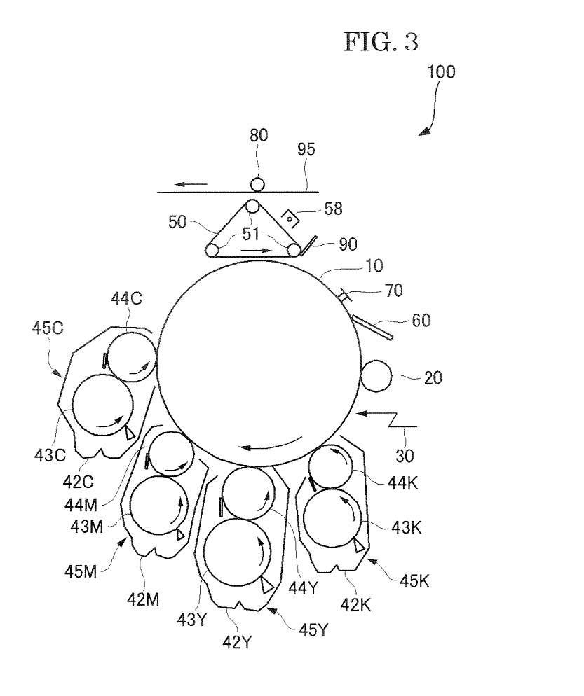

An embodiment of the image forming process using the image forming apparatus of the invention is described with reference to FIG. 2. The image forming apparatus 100 shown in FIG. 2 is equipped with a photoconductor drum 10 (hereafter referred to as “photoconductor 10”) as a latent electrostatic image bearing member, charge roller 20 as a charging unit, exposure unit 30, developing unit 40, intermediate transferring member 50, cleaning unit 60 having a cleaning blade, and discharge lamp 70 as a discharging unit.

The intermediate transferring member 50 is an endless belt being extended over the three rollers 51 placed inside the belt and designed to be moveable in arrow direction. A part of three rollers 51 function as a transfer bias roller capable of applying a specified transfer bias, the primary transfer bias, to the intermediate transferring member 50. The cleaning unit 90 with a cleaning blade is placed near the intermediate transferring member 50, and the transfer roller 80, as a transferring unit capable of applying the transfer bias for transferring the developed image onto the transfer paper 95 as the final transfer material, is placed face to face with the cleaning unit 90. In the surrounding area of the intermediate transferring member 50, the corona charger 58 is placed between contact area of the photoconductor 10 and the intermediate transferring member 50, and contact area of the intermediate transferring member 50 and the transfer paper 95, in the rotating direction of the intermediate transferring member 50.

The developing device 40 is constructed with developing belt 41 as a developer bearing member, black developing unit 45K, yellow developing unit 45Y, magenta developing unit 45M and cyan developing unit 45C disposed, together in the surrounding area of developing belt 41. The black developing unit 45K is equipped with developer container 42K, developer feeding roller 43K and developing roller 44K whereas yellow developing unit 45Y is equipped with developer container 42Y, developer feeding roller 43Y and developing roller 44Y. The magenta developing unit 45M is equipped with developer container 42M, developer feeding roller 43M and developing roller 44M whereas the cyan developing unit 45C is equipped with developer container 42C developer feeding roller 43C and developing roller 44C. The developing belt 41 is an endless belt and is extended between several belt rollers as rotatable, and the part of developing belt 41 is in contact with the photoconductor 10.

For example, the charge roller 20 charges the photoconductor drum 10 evenly in the image forming apparatus 100 as shown in FIG. 2. The exposure apparatus 30 exposes imagewise on the photoconductor drum 10 and forms a latent electrostatic image. The latent electrostatic image, formed on the photoconductor drum 10, is then developed with the toner fed from the developing unit 40 to form a toner image. The toner image is then transferred onto the intermediate transferring member 50 by the voltage applied from the roller 51 as the primary transferring and is further transferred onto the transfer paper 95 as the secondary transferring. As a result, a transfer image is formed on the transfer paper 95. The residual toner on the photoconductor 10 is removed by the cleaning unit 60 and the charge built up over the photoconductor 10 is temporarily removed by the discharge lamp 70.

The other aspect of the operation of image forming processes according to the present invention by image forming apparatuses of the invention is described with reference to FIG. 3. The image forming apparatus 100 as shown in FIG. 3 has the same construction as the image forming apparatus 100 shown in FIG. 2 except that the developing belt 41 is not equipped and the black developing unit 45K, the yellow developing unit 45Y, the magenta developing unit 45M and the cyan developing unit 45C are placed in the surrounding area directly facing the photoconductor 10. The reference numbers used in FIG. 3 correspond to those used in FIG. 2.

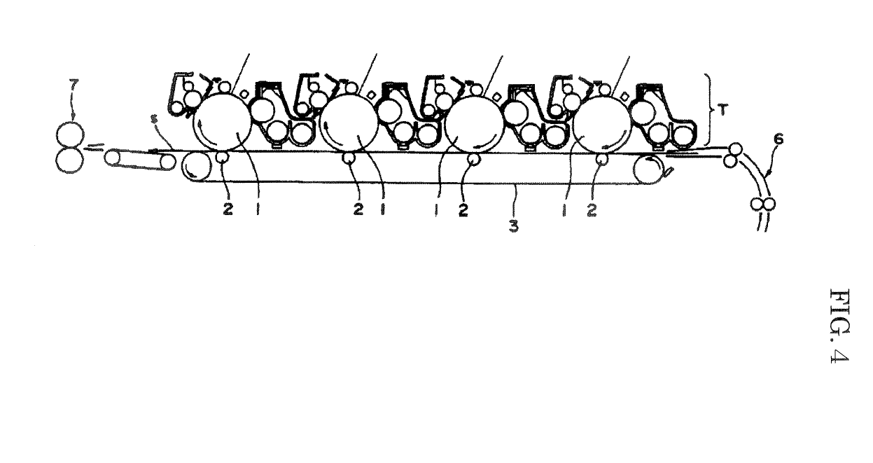

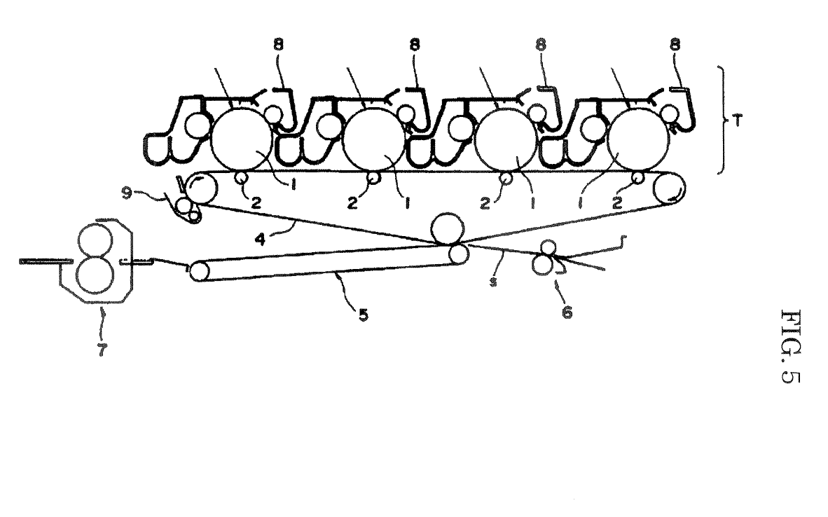

There are two types of tandem electrophotographic apparatus by which the image forming is performed by the image forming apparatus of the invention. In direct transfer type, images on the photoconductor 1 are transferred sequentially by the transferring unit 2 to the sheet “s” which is transported by the sheet transport belt 3 as shown in FIG. 4. In the indirect transfer type, images on the photoconductor 1 is temporarily transferred sequentially by the primary transferring unit 2 to the intermediate transferring member 4 is and then all the images on the intermediate transferring member 4 are transferred together to the sheet “s” by the secondary transferring unit as shown in FIG. 5. The transferring unit 5 is generally a transferring-transporting belt, and those of roller-type may be available.

The direct transfer type, when compared to the indirect transfer type, has a drawback of glowing in size because the paper feeding unit 6 must be placed on the upper side of the tandem image forming apparatus where the photoconductor 1 is aligned, whereas the fixing unit 7 must be placed on the lower side of the apparatus. On the other hand, in the indirect transfer type, the secondary transfer site may be installed relatively freely, and the paper feeding unit 6 and the fixing unit 7 may be placed together with the tandem image forming apparatus T, thus making it possible to be downsized.

In order to avoid size-glowing in the direction of sheet transportation, in the direct transfer type, the fixing unit 7 is to be placed close to the tandem-image forming apparatus T. Therefore, it is impossible to place the fixing unit 7 in a way that gives enough space for sheet “s” to bend, and the fixing unit 7 may affect the image forming on the upper side by the impact generated from the leading end of the sheet “s” as it approaches the fixing unit 7, or by the difference between the transport speed of the sheet when passing through the fixing unit 7 and when being transported by the transfer/transport belt. The indirect transfer type, on the other hand, allows the fixing unit 7 to be placed in a way that gives sheet “s” an enough space to bend and the fixing unit 7 has almost no effect on the image forming.

For the above reasons, the indirect transfer type of the tandem electrophotographic apparatus is particularly interested recently.

This type of color electrophotographic apparatus, as shown in FIG. 5, prepares for the next image forming by removing the residual toner on the photoconductor 1 by the photoconductor cleaning unit 8 to clean the surface of the photoconductor 1 after the primary transferring. It also prepares for the next image forming by removing the residual toner on the intermediate transferring member 4 by the intermediate transferring member cleaning unit 9 to clean the surface of the intermediate transferring member 4 after the secondary transferring.

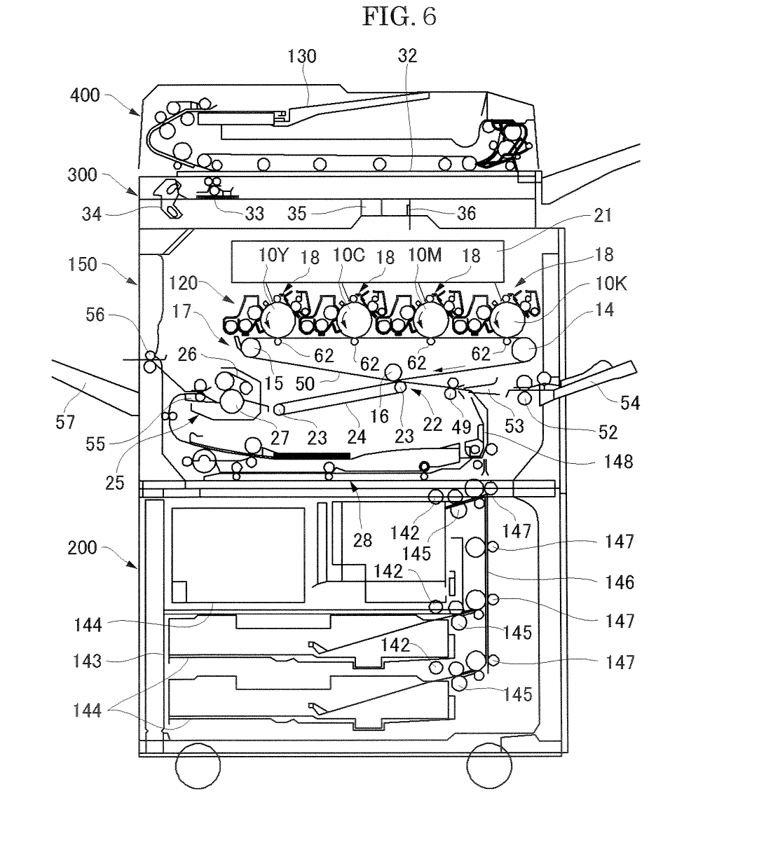

The tandem image forming apparatus 100, as shown in FIG. 6, is a tandem color image forming apparatus. The tandem image forming apparatus 120 is equipped with the copier main body 150, feeding paper table 200, scanner 300 and the automatic original-sheet feeder (ADF) 400.

The intermediate transferring member 50 in a form of an endless belt is placed in the central part of the copier main body 150. The intermediate transferring member 50 is extended between the support rollers 14, 15 and 16 as rotatable in the clockwise direction as shown in FIG. 6. The intermediate transferring member cleaning unit 17 is placed near the support roller 15 in order to remove the residual toner on the intermediate transferring member 50. The tandem developing unit 120, in which four image forming units 18, i.e. yellow, cyan, magenta and black, are positioned in line along the transport direction in the intermediate transferring member 50, which is extended between the support rollers 14 and 15. The exposure unit 21 is placed near the tandem developing unit 120. The secondary transferring unit 22 is placed on the opposite side where tandem developing unit 120 is placed in the intermediate transferring member 50. The secondary transfer belt 24, which being an endless belt, is extended between a pair of the rollers 23 and the transfer paper transported on the secondary transfer belt 24 and the intermediate transferring member 50 are accessible to each other in the secondary transferring unit 22. The fixing unit 25 is placed near the secondary transferring unit 22.

The sheet-reversing unit 28 is placed near the secondary transferring unit 22 and the fixing unit 25 in the tandem image forming apparatus 100, in order to invert the transfer paper to form images on both sides of the transfer paper.

The full-color image formation using the tandem developing unit 120 will be explained. Initially, an original sheet is set on the original-sheet table 130 of the automatic original-sheet feeder (ADF) 400, or the automatic original-sheet feeder 400 is opened and the original-sheet is set on the contact glass 32 of the scanner 300 and the automatic original-sheet feeder 400 is closed.

Upon pushing the start switch (not shown), the scanner 300 is activated after the original-sheet was transported and moved onto the contact glass 32 when the original-sheet was set on the automatic original-sheet feeder 400, or the scanner 300 is activated right after, when the original-sheet was set onto the contact glass 32, and the first carrier 33 and the second carrier 34 will start running. The light from the optical source is irradiated from the first carrier 33 simultaneously with the light reflected from the original-sheet surface is reflected by the mirror of second carrier 34. Then the scanning sensor 36 receives the light via the imaging lens 35 and the color copy (color image) is scanned to provide image information of black, yellow, magenta and cyan.

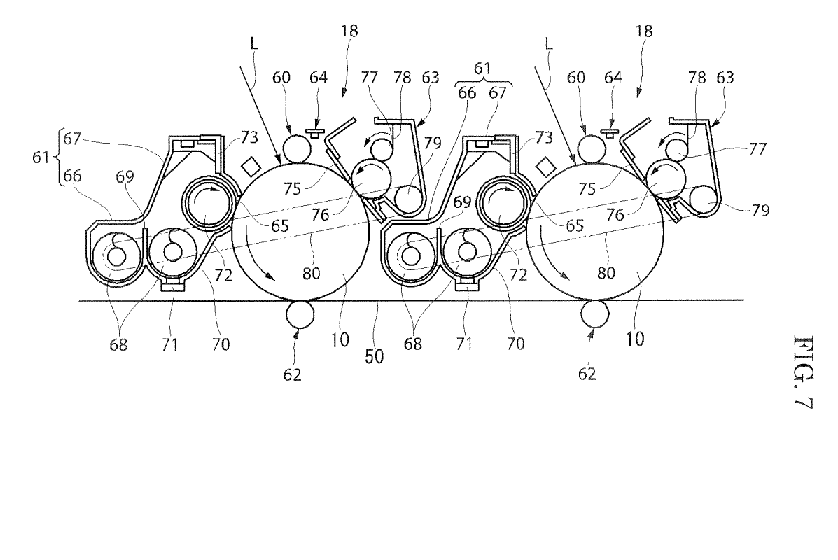

Each image information for black, yellow, magenta and cyan is transmitted to each image forming unit 18 of the tandem developing unit 120 and each toner image of black, yellow, magenta and cyan is formed in each image forming unit. The image forming unit 18 of the tandem image forming apparatus as shown in FIG. 7 is equipped with the photoconductor 10, the charger 60 that charges photoconductor evenly, an exposing unit by which the photoconductor is exposed imagewise corresponding to each color images based on each color image information as indicated by L in FIG. 7 to form a latent electrostatic image corresponding to each color image on the photoconductor, the developing unit 61 by which the latent electrostatic image is developed using each color toner to form toner images, the charge-transferring unit 62 by which the toner image is transferred onto the intermediate transferring member 50, the photoconductor cleaning unit 63 and the discharger 64. The image forming unit 18 can form each single-colored image based on color image information. These formed images are transferred sequentially onto the intermediate transferring member 50 which is rotationally transported by the support rollers 14, 15 and 16. And the black, yellow, magenta and cyan images are overlapped to form a synthesized color image, a color transfer image.

In the feeding table 200, one of the feeding roller 142 is selectively rotated and sheets are rendered out from one of the feeding cassettes equipped with multiple-stage in the paper bank 143 and sent out to feeding path 146 after being separated one by one by the separation roller 145. The sheets are then transported to the feeding path 148 in the copier main body 150 by the transport roller 147 and are stopped running down to the resist roller 49. Alternatively, sheets on the manual paper tray 54 are rendered out by the rotating feeding roller 142, inserted into the manual feeding path 53 after being separated one by one by the separation roller 52 and stopped by running down to the resist roller 49. Generally, the resist roller 49 is grounded, however, it is also usable while bias is imposed for the sheet powder removal.

The resist roller 49 is rotated on the synthesized color image on the intermediate transferring member 50 in a proper timing, and a sheet is sent out between the intermediate transferring member 50 and the secondary transferring unit 22. The color image is then formed on the sheet by transferring the synthesized color image by the secondary transferring unit 22. The residual toner on the intermediate transferring member 50 after the image transfer is cleaned by the intermediate transferring member cleaning unit 17.

The sheet or recording paper on which the color image is transferred and formed is taken out by the secondary transferring unit 22 and sent out to the fixing unit 25 in order to fix the synthesized color image onto the sheet or recording paper under the thermal pressure. Triggered by the switch claw 55, the sheet is discharged by the discharge roller 56 and stacked on the discharge tray 57. Alternatively, triggered by the switch 55, the sheet is inverted by the sheet-reversing unit 28 and led to the transfer position again. After recording an image on the reverse side, the sheet is then discharged by the discharge roller 56 and stacked on the discharge tray 57.

In the image forming methods and image forming apparatuses according to the present invention, the toners according to the present invention are utilized that may maintain proper transfer ability and cleaning property for long period, exhibit less image fluctuation, represent less embedding of external additives even under stirring the developer at use, and afford stable flowability and charging ability for long period, therefore, high-quality images may be formed efficiently.

### EXAMPLES

The present invention will be explained more specifically with reference to Examples and Comparative Examples, but these are to be construed as non-limiting the present invention. In the descriptions below, all percentages and parts are by mass unless indicated otherwise.

### Production Example 1

Synthesis of Organic Fine Particle Emulsion

A total of 683 parts of water, 11 parts of sodium salt of sulfate ester of methacrylic acid ethylene oxide adduct (Eleminol RS-30, by Sanyo Chemical Industries, Ltd.), 166 parts of methacrylic acid, 110 parts of butyl acrylate and 1 part of ammonium persulfate were filled into a reaction vessel, equipped with a stirrer and a thermometer, and the mixture was stirred at 3800 rpm for 30 minutes to prepare a white emulsified liquid, which was then heated to 75° C. to allow to react for 4 hours. To the reactant, 30 parts of 1% ammonium persulfate aqueous solution was further added to age at 75° C. for 6 hours, thereby to prepare an aqueous dispersion of vinyl resin (copolymer of methacrylic acid-butyl acrylate-sodium salt of sulfate ester of methacrylic acid ethylene oxide adduct) (hereinafter referred to as “Fine Particle Dispersion 1”). The mass-average particle diameter of fine particles in the Fine Particle Dispersion 1 was measured to be 110 nm by Nanotruck Particle Size Analyzer UPA-EX150 (by Nikkiso Co.). A portion of the Fine Particle Dispersion 1 was dried to sample the resin content, of which the glass transition temperature Tg was measured to be 58° C., and the mass-average molecular mass Mw was measured to be 130,000.

Preparation of Aqueous Phase

A total of 990 parts of water, 83 parts of the Fine Particle Dispersion 1, 37 parts of 48.3% aqueous solution of sodium dodecyldiphenylether disulfonate (Eleminol MON-7, by Sanyo Chemical Industries, Ltd.) and 90 parts of ethyl acetate were stirred to prepare an opalescent liquid (hereinafter referred to as “Aqueous Phase 1”).

Synthesis of Low Molecular-Mass Polyester

A total of 229 parts of bisphenol A ethylene oxide two-mole adduct, 529 parts of bisphenol A propylene oxide three-mole adduct, 208 parts of terephthalic acid, 46 parts of adipic acid and 2 parts of dibutyltin oxide were filled into a reactor vessel, equipped with a condenser, stirrer and nitrogen gas inlet, and the mixture was heated to 230° C. for 7 hours to allow to react under normal pressure. Then the mixture was allowed to react for 5 hours under a reduced pressure of 10 to 15 mm Hg, followed by adding 44 parts of trimellitic acid anhydride and further allowed to react at 180° C. for 3 hours under normal pressure thereby to prepare Low-Molecular-Mass Polyester 1.

The resulting Low-Molecular-Mass Polyester 1 was analyzed that the glass transition temperature Tg being 43° C., the mass-average-molecular mass Mw being 6700, the number-average-molecular mass being 2300, and the acid value being 25.

Synthesis of Prepolymer

A total of 682 parts of bisphenol A ethylene oxide two-mole adduct, 81 parts of bisphenol A propylene oxide two-mole adduct, 283 parts of terephthalic acid, 22 parts of trimellitic acid anhydride, and 2 parts of dibutyltin oxide were filled into a reactor vessel, equipped with a condenser, stirrer and nitrogen gas inlet, and the mixture was heated to 230° C. for 7 hours to allow to react under normal pressure. Then the reactant was further allowed to react for 5 hours under a reduced pressure of 10 to 15 mm Hg, thereby to prepare Intermediate Polyester 1.

The resulting Intermediate Polyester 1 was analyzed that the number-average-molecular mass being 2200, the mass-average-molecular mass Mw being 9700, the glass transition temperature Tg being 54° C., the acid value being 0.5, and the hydroxyl group value being 52.

Then 410 parts of the Intermediate Polyester 1, 89 parts of isophorone diisocyanate and 500 parts of ethyl acetate were poured into a reactor vessel, equipped with a condenser, stirrer and nitrogen gas inlet, and the mixture was reacted at 100° C. for 5 hours thereby to prepare Prepolymer 1. The content of free isocyanate was is 1.53% by mass in the Prepolymer 1.

Synthesis of Ketimine

A total of 170 parts of isophorone diamine and 75 parts of methylethylketone were filled into a reactor vessel, equipped with a stirrer and thermometer, and the mixture was reacted at 50° C. for 4.5 hours thereby to prepare Ketimine Compound 1. The Ketimine Compound 1 had an amine value of 417.

Preparation of Masterbatch

A total of 1200 parts of water, 540 parts of carbon black (Printex 35, by Degussa Co., DBP absorption number: 42 ml/100 mg, pH: 9.5) and 1200 parts of a polyester resin (by Sanyo Chemical Industries, Ltd., RS801) were mixed by use of Henschel mixer (by Mitsui Mining Co.). The resulting mixture was kneaded at 110° C. for 1 hour by use of twin rolls, then pressed and pulverized, thereby to prepare a carbon black masterbatch (hereinafter referred to as “Masterbatch 1”).

Preparation of Oil Phase

A total of 378 parts of the Low Molecular Mass Polyester 1, 100 parts of carnauba wax and 947 parts of ethyl acetate were filled into a reactor vessel, equipped with a stirrer and thermometer, and the mixture was heated to 80° C. while stirring and maintained at 80° C. for 5 hours, followed by cooling to 30° C. over 1 hour. Then 500 parts of Masterbatch 1 and 500 parts of ethyl acetate were filled into the reactor vessel and mixed for 1 hour to prepare a solution (hereinafter referred to as “Raw Solution 1”).

Then 1324 parts of the Raw Solution 1 was taken from the reactor vessel, a carbon black and a wax were dispersed into the Raw Solution 1 by use of a bead mill (Ultra Visco Mill, by Aymex Co.) in a condition of liquid-feed rate: 1 kg/hr, disc-circumferential velocity: 6 m/sec, amount of zirconia beads (0.5 mm): 80 volume %, and pass times: 3.

Then 1324 parts of 65% Low-Molecular-Mass Polyester 1 solution in ethyl acetate was added to the dispersion described above, and the mixture was further dispersed by use of the bead mill in the same condition except for the pass times being two, thereby to prepare a dispersion (hereinafter referred to as “Pigment-Wax Dispersion 1”).

The solid content of the Pigment-Wax Dispersion 1 was measured to be 50% under 130° C. for 30 minutes.

Emulsification

A total of 749 parts of the Pigment-Wax Dispersion 1, 115 parts of the Prepolymer 1 and 2.9 parts of the Ketimine Compound 1 were filled into a reactor vessel, then the mixture was stirred at 5000 rpm for 2 minutes by use of TK homomixer (by Primix Co.). Subsequently, 1200 parts of the Aqueous Phase 1 was added into the reactor vessel, the mixture was stirred at 13,000 rpm for 25 minutes by use of TK homomixer, thereby to prepare an aqueous dispersion (hereinafter referred to as “Emulsified Slurry 1”).

Removal of Organic Solvent

The Emulsified Slurry 1 was poured into a reactor vessel, equipped with a stirrer and thermometer, and the organic solvent was evaporated at 30° C. for 8 hours, then the remainder was aged at 40° C. for 4 hours, thereby to prepare a dispersion of which the organic solvent being removed (hereinafter referred to as “Dispersion Slurry 1”).

Rinsing and Drying

The Dispersion Slurry 1 in an amount of 100 parts was filtered under reduced pressure, then rinsed and dried in the following way:

(1) 100 parts of deionized water was added to the filtered cake, and the mixture was stirred at 12,000 rpm for 10 minutes by use of TK homomixer and then filtered.

(2) 100 parts of 10% sodium hydroxide aqueous solution was added to the filtered cake of (1), and the mixture was stirred at 12,000 rpm for 30 minutes by use of TK homomixer and then filtered.

(3) 100 parts of 10% hydrochloric acid aqueous solution was added to the filtered cake of (2), and the mixture was stirred at 12,000 rpm for 10 minutes by use of TK homomixer and then filtered.

(4) 100 parts of deionized water was added to the filtered cake of (3), and also was added a fluorochemical surfactant aqueous solution, as a charge control agent, in an amount of 0.1% as solid content based on the filter cake, then the mixture was stirred at 12,000 rpm for 10 minutes by use of TK homomixer and then filtered.

(5) 300 parts of deionized water was added to the filtered cake of (4), then the mixture was stirred at 12,000 rpm for 10 minutes by use of TK homomixer and filtered, thereafter the proceedings described above were repeated once more, thereby to prepare a filter cake.

The resulting filter cake was then dried at 45° C. for 48 hours using a air-circulation dryer, and screened through a mesh of opening 75 μm, thereby to prepare toner base particles (hereinafter referred to as “Toner Base Particles 1”).

The resulting Toner Base Particles 1 were analyzed in terms of mass-average particle diameter (D₄), particle size distribution (D₄/Dn), average circularity, and shape factors SF-1 and SF-2. As a result, the mass-average particle diameter (D₄) was 5.8 μm, the particle size distribution (D₄/Dn) was 1.15, the average circularity was 0.950, the shape factors SF-1 was 110, and the shape factor SF-2 was 115.

Mass Average Particle Diameter (D₄) and Particle Size Distribution (D₄/Dn)

The mass-average particle diameter and the particle size distribution of toners were measured by use of Coulter Counter TAII (Coulter Electronics Co.) in a condition of aperture diameter 100 μm. These results were used for calculating the ratio of mass-average particle diameter to number-average particle diameter.

Average Circularity

The average circularity was measured by use of a flow-type particle image analyzer FPIA-2100 (by Sysmex Co.). More specifically, 0.1 to 0.5 mL of an alkylbenzenesulfonate surfactant was added to 100 to 150 mL of purified water to prepare a solution, then each of toners was added to the solution in an amount of 0.1 to 0.5 g and was dispersed. The resulting dispersion was further dispersed by use of an ultrasonic agitator (by Honda Electronic Co.) for about 1 to 3 minutes to prepare a dispersion of concentration 3000 to 10,000 particles/μL, for which then the toner shape and particle size distribution were measured and the average circularity was calculated.

Shape Factors SF-1 and SF-2

The toners were taken picture by use of a scanning electron microscope (S-800, by Hitachi Ltd.), the image data were input into and analyzed by an image analyzer (Lusex 3, by Nireco Co.), and the shape factors were calculated.

$$SF - 1 = \frac{{( MXLNG )}^{2}}{AREA} \times \frac{π}{4} \times 100 \text{:} \qquad Equation ( 1 )$$

The “MXLNG” in the Equation (1) represents the maximum length of the projected shape of the toner particle on two-dimensional plane. The “AREA” represents the area of the projected shape of the toner particle on two-dimensional plane.

$$SF - 2 = \frac{{( PERI )}^{2}}{AREA} \times \frac{1}{4 π} \times 100 \text{:} \qquad Equation ( 2 )$$

The “PERI” in the Equation (2) represents the peripheral length of the projected shape of the toner particle on two-dimensional plane. The “AREA” represents the area of the projected shape of the toner particle on two-dimensional plane.

Preparation of Carrier

A total of 200 parts of toluene, 200 parts of a silicone resin (SR2400, by Dow Corning Toray Silicone Co., nonvolatile content: 50%), 7 parts of an aminosilane (SH6020, by Dow Corning Toray Silicone Co.) and 4 parts of carbon black were dispersed by use of a stirrer for 10 minutes to prepare a coating liquid.

The resulting coating liquid and 5000 parts of Mn ferrite particles (mass-average particle diameter: 35 μm) of a core material were filled into a coating device, then the coating liquid was coated on the core material while forming a swirling flow within the coating device by action of a rotatable bottom disc and stirring blades in a fluidized bed. The resulting coated material was heated at 250° C. for 2 hours in an electric furnace to prepare a carrier.

Preparation of External Additive

External additives A to C were prepared through surface-treating as shown in Table 1

| | | | Primary | | |
|---|---|---|---|---|---|
| | | | Particle | | |
| | | Material | Diameter | Surface-Treating Agent | |
| External | A | Silica | 12 nm | hexamethyl | — |
| Additive | | | | disilazane | |
| | B | Titanium | 15 nm | methyl- | perfluoropropyl |
| | | Oxide | | trimethoxy | trimethoxysilane |
| | | | | silane | |
| | C | Silica | 120 nm | hexamethyl | — |
| | | | | disilazane | |

Preparation of Secondary Agglomerates

Ten parts of the External Additive B, shown in Table 1, was dispersed and stirred in 100 parts of methanol, then the External Additive B was precipitated through centrifugal separation. Then the precipitate was air-dried, and the resulting dry material was loosened in a ball mill with steel balls of 10 mm diameter. The loosened material was screened through 400 mesh and collected to prepare a secondary agglomerates (hereinafter referred to as “External Additive D”).

The secondary agglomerates were observed and analyzed by use of an electron microscope and a fluorescence X-ray analyzer, which demonstrated that the main ingredient was titanium oxide fine particles, the secondary particle diameter of the secondary agglomerates was 22 μm, and the secondary agglomerates contained the titanium oxide fine particles having primary particle diameters of 80 to 150 nm in a content of 60%.

### Examples 1 to 5 and Comparative Example 1

To 100 parts of the Toner Base Particles 1, External Additives 1 to 3 and the secondary agglomerates were added under the formulations shown in Table 2, and the mixtures were respectively stirred by Henschel mixer. After the stirring, the powder was screened through a mesh of opening 100 μm to remove coarse particles, thereby to prepare toners A to H.

TABLE 2

External Additive
(mass amount by part)

| | A | B | C | D |
|---|---|---|---|---|
| toner A | 0.5 | 0.5 | 0.5 | 0.05 |
| toner B | 1.5 | 0.75 | 1 | 0.1 |
| toner C | 1.5 | 0.5 | 0.5 | 0.1 |
| toner D | 1.5 | 0.5 | 0.5 | 0.2 |
| toner E | 1.5 | 0.75 | 0.5 | 0.2 |
| toner F | 1.5 | 0.75 | 0.5 | 0.5 |
| toner G | 1.5 | 0.75 | 1.2 | 0 |
| toner H | 1.5 | 0.75 | 0.6 | 0.6 |

Each of the toners in Examples 1 to 5 and Comparative Examples 1 to 2 was measured with respect to the number of secondary agglomerates in the manner shown below. The results are shown in Table 3.

Measurement of Number of Secondary Agglomerates

The content or number of secondary agglomerates having a secondary particle diameter of no less than 10 μm was measured in accordance with the following way. A cage screen was made from a screen material of 635 mesh into a form of closed cylinder, in which the cylinder diameter being 24 mm, the cylinder height being 7 mm, and two cylinder faces of circular mesh being disposed oppositely. A toner was weighed into the cage screen in an amount of 0.2 g. An air suction of a toner cleaner (CV-TN96, by Hitachi Ltd.) was disposed near one of two cylinder faces, and arranged to suck near the cylinder face at a suction pressure of 5 mmHg while adjusting the pressure using a transformer, and also air was blown from 160 mm high above another cylinder face at a blowing pressure of 0.2 MPa, thereby to remove the toner within the cage screen. Finally, air aspiration was carried out by the toner cleaner at a suction pressure of 20 mmHg to remove the toner. In cases where the toner removal was incomplete, these operations were repeated till removing the toner completely. The residual matter remaining on the screen was observed by a digital microscope (Keyence VHX-100) at a magnification of 150×, and the number of secondary agglomerates on the screen was counted. These operations were carried out for 20 view fields and the content or number of secondary agglomerates in the toner was determined.

TABLE 3

| | Ex. 1 | Ex. 2 | Ex. 3 | Ex. 4 | Ex. 5 | Ex. 6 | Com. Ex. 1 |
|---|---|---|---|---|---|---|---|
| Toner | A | B | C | D | E | F | G |
| Number of | 20 | 94 | 38 | 180 | 320 | 740 | 0 |
| Sec. Agg. (/g) | | | | | | | |

Sec. Agg.: secondary agglomerates

Preparation of Developer

Each of the toners in Examples 1 to 6 and Comparative Example 1, of an amount of 7 parts, and 100 parts of the carrier described above were mixed uniformly by use of a tumbler mixer and charged, thereby to produce the respective developers.

The resulting developers were filled into an image forming apparatus (by Ricoh Co., IPSiO Color 8100), from which images were formed and evaluated as flows. The results are shown in Table 4.

Image Density

A solid image was formed on a recording medium of regular paper (by Ricoh Co., Type 6200) at a toner amount of 0.3±0.1 mg/cm², and the image density was measured by use of X-Rite densitometer (by X-Rite Co.) and evaluated in accordance with the following criteria.

Evaluation Criteria

A: no less than 1.4 of image density

B: no less than 1.2 and less than 1.4 of image density

C: less than 1.2 of image density

Fixing Ability (Hot Offset Resistance)

An image forming apparatus (by Ricoh Co., IPSiO Color 8100), which had been modified to remove its fixing-oil coating unit, was employed for fixing test with changing the temperature of the fixing belt. The maximum temperature, up to which no hot offset occurs on regular paper, was defined as the maximum fixing temperature. The minimum fixing temperature was measured using heavy paper in a way that a fixed image was rubbed with a pad and the fixing roll temperature, down to which the residual rate of image density being no less than 70% after rubbing based on before rubbing, was determined as the minimum fixing temperature. It is preferred that the maximum fixing temperature is no lower than 200° C. and the minimum fixing temperature is no higher than 140° C.

A solid image was printed and evaluated on regular paper and heavy paper (by Ricoh Co., Type 6200, and by NBS Ricoh Co., Copy Print Paper 135) at a toner amount of 1.0±0.1 mg/cm².

Evaluation Criteria

A: less than 130° C. of minimum fixing temperature

B: no less than 130° C. and less than 140° C. of minimum fixing temperature

C: no less than 140° C. of minimum fixing temperature

Cleaning Property

A photoconductor was used to print 1000 sheets with an image area of 95% and then cleaned through a cleaning step. The residual toner on the photoconductor was transferred onto a white paper by use of a scotch tape (by Sumitomo 3M Ltd.), and the white paper was measured using MacBeth reflective densitometer model RD514 and evaluated under the following criteria.

Evaluation Criteria

A: difference with blank<0.005

B: 0.005≦difference with blank<0.010

C: 0.010≦difference with blank≦0.02

D: 0.02<difference with blank

A chart with an image area of 20% was transferred from a photoconductor to paper, then the residual toner on the photoconductor before cleaning was transferred onto a white paper by use of a scotch tape (by Sumitomo 3M Ltd.) and the white paper was measured using MacBeth reflective densitometer model RD514 and evaluated under the following criteria.

Evaluation Criteria

A: difference with blank<0.005

B: 0.005≦difference with blank<0.010

C: 0.010≦difference with blank≦0.02

D: 0.02<difference with blank

Image Granularity and Sharpness

A photographic image was printed in a mono color, and the image was evaluated under the following criteria.

Evaluation Criteria

A: equivalent with offset print

B: somewhat inferior to offset print

C: significantly inferior to offset print

D: similar with conventional electrophotographic images, i.e. remarkably inferior

Fog

An image forming apparatus (by Ricoh Co., IPSiO Color 8100) was modified and tuned to an oilless fixing device to fabricate a test apparatus. An endurance test was carried out by way of printing successively 100,000 sheets of a chart with 5% image area from each toner at temperature 10° C. and relative humidity 15% using the test apparatus, and the smear due to the residual toner on background portions of recording media was visually observed using a loupe and evaluated under the following criteria.

Evaluation Criteria

A: no smear, i.e. appropriate condition

B: slight smear, i.e. substantially no problem

C: a little observable smear

D: significant smear, i.e. problematic and unallowable

Toner Scattering

By use of a test apparatus, fabricated from an image forming apparatus (by Ricoh Co., IPSiO Color 8100) to modify and tune into an oilless fixing device, an endurance test was carried out by way of printing successively 100,000 sheets of a chart with 5% image area from each toner at temperature 40° C. and relative humidity 90% using the test apparatus, and then pollution within the test apparatus was visually observed and evaluated under the following criteria.

Evaluation Criteria

A: no toner pollution, i.e. appropriate condition

B: slight pollution, i.e. substantially no problem

C: a little observable pollution

D: significant pollution, i.e. problematic and unallowable

Environmental Storage Stability (Blocking Resistance)

A toner was weighed in an amount of 10 g and filled into a 20 mL glass vessel, which was then tapped 100 times followed by allowing to stand in a higher temperature-humidity condition of temperature 55° C. and relative humidity 80% for 24 hours, then penetration level of the toner was measured using a penetration meter. The toner in the glass vessel was also allowed to stand in a lower temperature-humidity condition of temperature 10° C. and relative humidity 15% for 24 hours, then penetration level of the toner was measured using a penetration meter. Comparing the two penetration levels of the above, lower penetration level was employed for the evaluation.

Evaluation Criteria

A: 20 mm≦penetration level

B: 15 mm≦penetration level<20 mm

C: 10 mm≦penetration level<15 mm

D: penetration level<10 mm

Charge Stability

An endurance test was carried out by way of printing successively 100,000 sheets of letter image with 12% image area, and the difference of charge amounts was evaluated. A small amount of developer was sampled from a sleeve and the difference of charge amounts was measured obtained by a blow-off method and evaluated under the following criteria.

A: difference of charge amount<5 μc/g

B: 5 μc/g≦difference of charge amount≦10 μc/g

C: 10 μc/g<difference of charge amount

TABLE 4

| | | Image | | Transfer | | Image | | Charge | | Fixing | | | | |
|---|---|---|---|---|---|---|---|---|---|---|---|---|---|---|
| | | Density | | Ability | | Granularity | | Stability | | Ability | CP | Fog | TS | ESS |
| | Toner | IT | AP | IT | AP | IT | AP | IT | AP | IT | IT | IT | IT | IT |
| Ex. 1 | A | A | B | A | C | A | C | A | B | A | A | A | A | A |
| Ex. 2 | B | A | A | B | B | B | B | A | A | A | B | B | B | B |
| Ex. 3 | C | A | A | A | B | A | B | A | A | A | A | A | A | A |
| Ex. 4 | D | A | A | B | B | B | B | A | A | A | B | B | B | B |
| Ex. 5 | E | A | A | B | C | B | C | B | B | A | C | B | B | B |
| Ex. 6 | F | A | A | B | C | C | C | B | B | A | C | B | B | B |
| Com. Ex. 1 | G | C | C | D | D | D | D | C | C | C | D | D | D | D |

IT: initial
AP: after printing 10,000 sheets
CP: cleaning property
TS: toner scattering
ESS: environmental storage stability

The toners according to the present invention may maintain proper transfer ability and cleaning property for long period, exhibit less image fluctuation, represent less embedding or burial of external additives even under stirring the developer at use, and exhibit excellent stability in terms of flowability and charging property for long period, accordingly are favorably utilized for forming high-quality images.

The developers containing the inventive toners, toner-containing containers, process cartridges, image forming apparatuses and image forming methods according to the present invention may also favorably utilized for forming high-quality images.

What is claimed is:

1. A toner, comprising toner base particles and secondary agglomerates,
wherein the toner base particles comprise a toner material that comprises a colorant and a binding resin, and
the secondary agglomerates, which being formed of fine particles, each have a secondary particle diameter of no less than 10 μm

2. The toner according to claim 1, comprising toner base particles and secondary agglomerates,
wherein the toner base particles comprise a toner material that comprises a colorant and a binding resin,
the secondary agglomerates, which being formed of fine particles, each have a secondary particle diameter of no less than 10 μm, and
the number of the secondary agglomerates is 5 to 800 per gram of the toner.

3. The toner according to claim 1, wherein the secondary particle diameter of the secondary agglomerates is 10 to 50 μm, and the number of the secondary agglomerates is 5 to 200 per gram of the toner.

4. The toner according to claim 1, wherein the fine particles comprise smaller-diameter particles each having a primary particle diameter of 1 to 30 nm and larger-diameter particles each having a primary particle diameter of 30 to 200 nm.

5. The toner according to claim 1, wherein the secondary agglomerates comprise titanium oxide fine particles each having a primary particle diameter of 80 to 150 nm in an amount of no less than 50%.

6. The toner according to claim 1, wherein the toner is formed into particles by way of emulsifying or dispersing a solution or a dispersion of the toner material into an aqueous medium.

7. The toner according to claim 6, wherein the solution or the dispersion of the toner material comprises an organic solvent, and the organic solvent is removed at forming the particles or after forming the particles.

8. The toner according to claim 6, wherein the toner material comprises an active hydrogen group-containing compound and a polymer reactive with the active hydrogen group-containing compound, and the toner is formed into particles by way of reacting the active hydrogen group-containing compound and the polymer reactive with the active hydrogen group-containing compound to form an adhesive base material, and then forming particles that contain at least the adhesive base material.

9. The toner according to claim 8, wherein the polymer reactive with the active hydrogen group-containing compound comprises a modified polyester resin.

10. The toner according to claim 1, wherein the binding resin in the toner material is an unmodified polyester resin.

11. The toner according to claim 1, wherein the average circularity of the toner is 0.90 to 0.99.

12. The toner according to claim 1, wherein the shape factor SF-1, expressed by the Equation (1) below to represent a spherical level, is 100 to 150 and the shape factor SF-2, expressed by the Equation (2) to represent an irregularity level, is 100 to 140;
$$SF - 1 = \frac{{( MXLNG )}^{2}}{AREA} \times \frac{π}{4} \times 100 \text{:} \qquad Equation ( 1 )$$
wherein the “MXLNG” in the Equation (1) represents the maximum length of the projected shape of the toner particle on two-dimensional plane, and the “AREA” represents the area of the projected shape of the toner particle on two-dimensional plane; and
$$SF - 2 = \frac{{( PERI )}^{2}}{AREA} \times \frac{1}{4 π} \times 100 \text{:} \qquad Equation ( 2 )$$
wherein the “PERI” in the Equation (2) represents the peripheral length of the projected shape of the toner particle on two-dimensional plane, and the “AREA” represents the area of the projected shape of the toner particle on two-dimensional plane.

13. The toner according to claim 1, wherein the mass-average particle diameter (D₄) of the toner is 2 to 7 μm, and the ratio (D₄/Dn) of mass-average particle diameter (D₄) to number-average particle diameter (Dn) is no more than 1.25.

14. A developer, comprising a toner that comprises toner base particles and secondary agglomerates,
wherein the toner base particles comprise a toner material that comprises a colorant and a binding resin, and
the secondary agglomerates, which being formed of fine particles, each have a secondary particle diameter of no less than 10 μm.

15. The developer according to claim 14, wherein the developer is of one-component or two-component.

16. A toner-containing container, comprising a toner that comprises toner base particles and secondary agglomerates,
wherein the toner base particles comprise a toner material that comprises a colorant and a binding resin, and
the secondary agglomerates, which being formed of fine particles, each have a secondary particle diameter of no less than 10 μm.

17. A process cartridge, comprising a latent electrostatic image bearing member and a developing unit,
wherein the developing unit is configured to form a visible image from a latent electrostatic image formed on the latent electrostatic image bearing member by use of a toner that comprises toner base particles and secondary agglomerates, and
wherein the toner base particles comprise a toner material that comprises a colorant and a binding resin, and the secondary agglomerates, which being formed of fine particles, each have a secondary particle diameter of no less than 10 μm.

18. An image forming apparatus comprising:
a latent electrostatic image bearing member,
a latent electrostatic image forming unit configured to form a latent electrostatic image on the latent electrostatic image bearing member,
a developing unit configured to form a visible image from a latent electrostatic image formed on the latent electrostatic image bearing member by use of a toner,
a transferring unit configured to transfer the visible image to a recording medium, and
a fixing unit configured to fix the transferred image to the recording medium,
wherein the toner comprises toner base particles and secondary agglomerates, the toner base particles comprise a toner material that comprises a colorant and a binding resin, and the secondary agglomerates, which being formed of fine particles, each have a secondary particle diameter of no less than 10 μm.

19. An image forming method comprising:
forming a latent electrostatic image on a latent electrostatic image bearing member,
developing the latent electrostatic image by use of a toner,
transferring the visible image to a recording medium, and
fixing the transferred image to the recording medium,
wherein the toner comprises toner base particles and secondary agglomerates, the toner base particles comprise a toner material that comprises a colorant and a binding resin, and the secondary agglomerates, which being formed of fine particles, each have a secondary particle diameter of no less than 10 μm.
